(19) United States
(12) Patent Application Publication
(10) Pub. No.: US 2026/0177433 A1
(43) Pub. Date: Jun. 25, 2026

(54) CAPACITANCE SENSOR, SENSOR SHEET, SENSOR UNIT, DETECTION CIRCUIT, AND CAPACITANCE DETECTION DEVICE

(71) Applicant: ALPS ALPINE CO., LTD., Tokyo (JP)

(72) Inventors: Takashi NISHIYAMA, Ningbo (CN); Takeya INOMATA, Niigata (JP); Akihiro TAKEDA, Fukushima (JP); Shinichi HIGUCHI, Fukushima (JP)

(21) Appl. No.: 19/542,068

(22) Filed: Feb. 17, 2026

Related U.S. Application Data
(63) Continuation of application No. PCT/JP2024/030340, filed on Aug. 26, 2024.

(30) Foreign Application Priority Data
Aug. 28, 2023 (JP) 2023-138435

(51) Int. Cl. G01L 1/14

(52) U.S. Cl. CPC G01L 1/146

(57) ABSTRACT

A capacitance sensor includes: a substrate; a detection electrode disposed on one surface of the substrate; a first side shield electrode disposed parallel with the detection electrode on the one surface of the substrate; and a back shield electrode disposed on the other surface of the substrate to face the detection electrode through the substrate. A first AC drive voltage is applied to the detection electrode. A second AC drive voltage having a same frequency and a same phase as those of the first AC drive voltage is applied to the first side shield electrode and the back shield electrode. The capacitance sensor further includes a side ground electrode that is disposed parallel with the detection electrode and the first side shield electrode on the one surface of the substrate, and is connected to a ground potential.

### CROSS-REFERENCE TO RELATED APPLICATIONS

This application is a continuation application of International Application No. PCT/JP2024/030340, filed on Aug. 26, 2024, and designating the U.S., which is based upon and claims priority to Japanese Patent Application No. 2023-138435, filed on Aug. 28, 2023, the entire contents of which are incorporated herein by reference.

### BACKGROUND

### Technical Field

The present invention relates to a capacitance sensor, a sensor sheet, a sensor unit, a detection circuit, and a capacitance detection device.

### Background Art

International Publication No. WO 2009/044920 identified below discloses a technique related to a capacitive proximity sensor including a sensor electrode, an auxiliary electrode disposed near the sensor electrode, and a shield electrode disposed on the back surface side of the sensor electrode, wherein the technique applies a potential equivalent to that of the sensor electrode to the auxiliary electrode and the shield electrode.

International Publication No. WO 2018/116706 and International Publication No. WO 2021/090636 identified below disclose a technique related to a capacitance detection device including a shield electrode disposed on the back surface side of a detection electrode, wherein the technique adjusts a second alternating-current (AC) voltage such that a drive current for the detection electrode becomes zero when there is no target that approaches the detection electrode.

International Publication No. WO 2021/090636 identified below discloses a technique related to a capacitance detection device including a detection electrode, and a shield electrode disposed on the back surface side of the detection electrode, wherein the technique adjusts a second AC voltage such that the amplitude of an operational amplifier becomes smaller than the amplitude of a first AC voltage supplied to the shield electrode.

### SUMMARY

However, when the conductivity or the dielectric constant of the detection target is low, the techniques of International Publication No. WO 2009/044920, International Publication No. WO 2018/116706, and International Publication No. WO 2021/090636 cannot detect the detection target with a high sensitivity because the capacitance of the detection target that can be detected by the detection electrode is low.

A capacitance sensor according to an embodiment includes: a substrate; a detection electrode disposed on one surface of the substrate; a first side shield electrode disposed parallel with the detection electrode on the one surface of the substrate; and a back shield electrode disposed on the other surface of the substrate to face the detection electrode through the substrate, wherein a first alternating-current (AC) drive voltage is applied to the detection electrode, a second AC drive voltage having a same frequency and a same phase as those of the first AC drive voltage is applied to the first side shield electrode and the back shield electrode, and the capacitance sensor further includes a side ground electrode that is disposed parallel with the detection electrode and the first side shield electrode on the one surface of the substrate, and is connected to a ground potential.

According to the capacitance sensor of an embodiment, a detection target having a low conductivity or a low dielectric constant can be detected with a high sensitivity.

### BRIEF DESCRIPTION OF THE DRAWINGS

FIG. 1 is a plan view of a capacitance detection device according to a first embodiment;

FIG. 2 is an exploded plan view of a capacitance sensor according to the first embodiment;

FIG. 3 is a cross-sectional view of the capacitance sensor according to the first embodiment;

FIG. 4 is a diagram showing a parasitic capacitance generated in the capacitance sensor according to the first embodiment;

FIG. 5 is a diagram showing a circuit model of the capacitance detection device according to the first embodiment (when a detection target is not present on the capacitance sensor);

FIG. 6 is a diagram showing a circuit model of the capacitance detection unit according to the first embodiment (when a detection target is present on the capacitance sensor);

FIG. 7 is a diagram showing a configuration example of a circuit of a capacitance detection unit included in the capacitance detection device according to the first embodiment;

FIG. 8 is an exploded plan view of a capacitance sensor according to a second embodiment;

FIG. 9 is a cross-sectional view of the capacitance sensor according to the second embodiment;

FIG. 10 is a diagram showing parasitic capacitance generated in the capacitance sensor according to the second embodiment;

FIG. 11 is a diagram showing a circuit model of a capacitance detection device according to the second embodiment (when a detection target is not present on the capacitance sensor);

FIG. 12 is a diagram showing a circuit model of the capacitance detection device according to the second embodiment (when a detection target is present on the capacitance sensor);

FIG. 13 is a diagram showing an example of how a detection target is detected by the capacitance sensor according to the second embodiment;

FIG. 14 is an exploded plan view of a capacitance sensor according to a third embodiment;

FIG. 15 is a cross-sectional view of the capacitance sensor according to the third embodiment;

FIG. 16 is a diagram showing a circuit model of a capacitance detection device according to the third embodiment (when a detection target is not present on the capacitance sensor);

FIG. 17 is a diagram showing a circuit model of the capacitance detection device according to the third embodiment (when a detection target is present on the capacitance sensor);

FIG. 18 is a diagram showing an example of how a detection target is detected by the capacitance sensor according to the third embodiment;

FIG. 19 is an exploded plan view of a conventional capacitance sensor;

FIG. 20 is a cross-sectional view of the conventional capacitance sensor;

FIG. 21 is a diagram showing a circuit model of a conventional capacitance detection system (when a detection target is not present on the conventional capacitance sensor);

FIG. 22 is a diagram showing a circuit model of the conventional capacitance detection system (when a detection target is present on the conventional capacitance sensor);

FIG. 23 is a diagram showing an example of how a detection target is detected by the conventional capacitance sensor;

FIG. 24 is a table showing a list of products used in a first experiment example and a second experiment example;

FIG. 25 is a table showing a list of detection results in the first experiment example and the second experiment example;

FIG. 26 is a table showing a list of products used in a third experiment example;

FIG. 27A is a diagram showing a first example of the experimental procedure in the third experiment example;

FIG. 27B is a diagram showing the first example of the experimental procedure in the third experiment example;

FIG. 27C is a diagram showing the first example of the experimental procedure in the third experiment example;

FIG. 28A is a diagram showing a second example of the experimental procedure in the third experiment example;

FIG. 28B is a diagram showing the second example of the experimental procedure in the third experiment example;

FIG. 28C is a diagram showing the second example of the experimental procedure in the third experiment example;

FIG. 29 is a table showing a list of detection results in the third experiment example;

FIG. 30 is an exploded plan view of a capacitance sensor according to a first modified example;

FIG. 31 is a cross-sectional view of the capacitance sensor according to the first modified example;

FIG. 32 is a diagram showing an example of how a detection target is detected by the capacitance sensor according to the first modified example;

FIG. 33 is a plan view of a capacitance sensor according to a second modified example;

FIG. 34 is a cross-sectional view of the capacitance sensor according to the second modified example;

FIG. 35 is a plan view of a capacitance sensor according to a third modified example;

FIG. 36 is a cross-sectional view of a capacitance sensor according to the third modified example;

FIG. 37 is a cross-sectional view of a capacitance sensor according to a fourth modified example;

FIG. 38 is a cross-sectional view of a capacitance sensor according to a fifth modified example;

FIG. 39 is a cross-sectional view of a capacitance sensor according to a sixth modified example;

FIG. 40 is a plan view of a capacitance detection device according to a seventh modified example;

FIG. 41 is a plan view of a capacitance detection device according to an eighth modified example;

FIG. 42 is a plan view of a capacitance detection device according to a ninth modified example;

FIG. 43 is a plan view of a capacitance sensor according to the fifth modified example;

FIG. 44 is a cross-sectional view of a capacitance sensor according to the fifth modified example;

FIG. 45 is a diagram showing a circuit model of a capacitance detection device according to the fifth modified example (when a detection target is not present on the capacitance sensor);

FIG. 46 is a diagram showing a circuit model of the capacitance detection device according to the fifth modified example (when a detection target is present on the capacitance sensor);

FIG. 47 is a table showing products used in a fourth experiment example; and

FIG. 48 is a table showing a list of detection results in the fourth experiment example.

### DETAILED DESCRIPTION OF THE INVENTION

Hereinafter, one embodiment will be described with reference to the drawings. In the following description, for the sake of convenience, the X-axis direction is defined as the left-right direction, the Y-axis direction is defined as the front-rear direction, and the Z-axis direction is defined as the up-down direction. Here, the positive direction on the X-axis is defined as the right direction, the positive direction on the Y-axis is defined as the front direction, and the positive direction on the Z-axis is defined as to the upward direction. These indicate the relative positional relationship in a device, and do not limit the installation direction or operation direction of the device. All modes that share an equivalent relative positional relationship in the device, including any modes that are varied in the installation direction or operation direction of the device, are intended to be included in the scope of the right of the present invention.

### First Embodiment

### (Outline of Capacitance Detection Device 10)

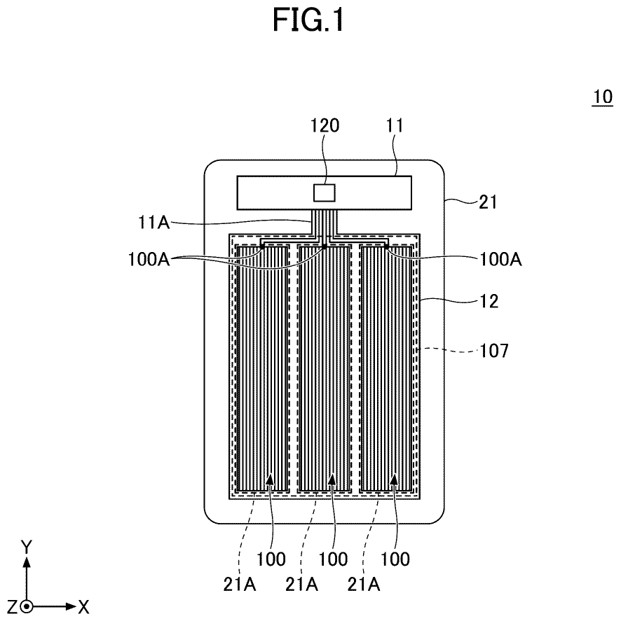

FIG. 1 is a plan view of a capacitance detection device 10 according to a first embodiment. As shown in FIG. 1, the capacitance detection device 10 includes a sensor sheet 12. The sensor sheet 12 includes a plurality of capacitance sensors 100 (in the example shown in FIG. 1, three capacitance sensors 100) disposed parallel with each other in the left-right direction (X-axis direction).

Each of the capacitance sensors 100 included in the sensor sheet 12 is a sheet-like sensor that linearly extends in the front-rear direction (Y-axis direction). Each of the capacitance sensors 100 included in the sensor sheet 12 is configured to detect a detection target 20 mounted on the capacitance sensor 100 by a self-capacitance method. The entirety of the sensor sheet 12 is covered with a cover 107.

The capacitance detection device 10 includes a circuit board 11 and a detection circuit 120 provided on the circuit board 11. The detection circuit 120 is connected to the plurality of capacitance sensors 100 provided on the sensor sheet 12 via lead wires 11A, respectively. Each of the plurality of capacitance sensors 100 provided on the sensor sheet 12 includes a connection part 100A for connection to the lead wire 11A that is provided at an end on the positive side on the Y-axis (one end part in a first direction). By driving each of the plurality of capacitance sensors 100 provided on the sensor sheet 12, the detection circuit 120 enables each of the plurality of capacitance sensors 100 provided on the sensor sheet 12 to detect the detection target 20, in order to be able to acquire a result of detection of the detection target 20 from each of the plurality of capacitance sensors 100 provided on the sensor sheet 12.

For example, the capacitance detection device 10 can be used to detect a display state of products on a shelf board 21 of a product shelf in a store selling a plurality of products. For example, in the example shown in FIG. 1, the sensor sheet 12 of the capacitance detection device 10 includes the capacitance sensor 100 for each of the plurality of product rows 21A (in the example shown in FIG. 1, three product rows 21A) on the shelf board 21 of the product shelf. Thus, the capacitance detection device 10 can detect the display states of products (the presence or absence of products, the number of products, and the like) in the plurality of product rows 21A by a self-capacitance method using the plurality of capacitance sensors 100 provided on the sensor sheet 12, respectively.

### (Configuration of Capacitance Sensor 100)

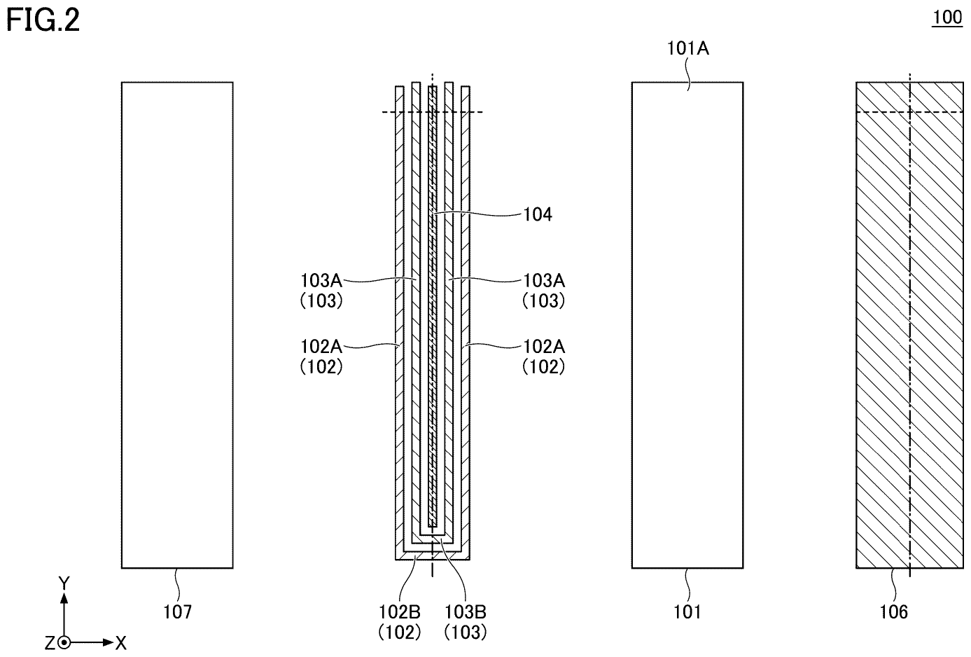

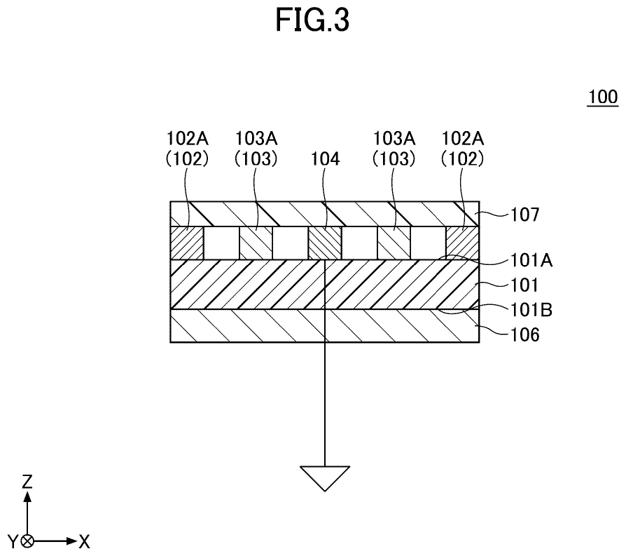

FIG. 2 is an exploded plan view of the capacitance sensor 100 according to the first embodiment. FIG. 3 is a cross-sectional view of the capacitance sensor 100 according to the first embodiment.

As shown in FIGS. 2 and 3, the capacitance sensor 100 according to the first embodiment includes a substrate 101, a detection electrode 102, a first side shield electrode 103, a side ground electrode 104, a back shield electrode 106, and the cover 107.

The substrate 101 is a plate-like member composed of an insulating material and configured to support each electrode (the detection electrode 102, the first side shield electrode 103, the side ground electrode 104, and the back shield electrode 106). The substrate 101 has a rectangular shape having a constant width in the left-right direction (the X-axis direction) and a constant length in the front-rear direction (the Y-axis direction) in a plan view viewed from above (the positive direction on the Z-axis). The substrate 101 is composed of, for example, an insulating resin, such as polyethylene terephthalate (PET), polymethyl methacrylate (PMMA), and the like, glass, glass epoxy resin, glass polyimide resin, paper epoxy resin, paper phenol resin, or the like. The substrate 101 may be formed integrally with the circuit board 11.

The detection electrode 102 is a thin film-like electrode composed of a conductive material, such as a metal, inorganic conductive oxide, conductive resin, and the like and provided on an upper surface 101A (an example of “one surface”) of the substrate 101. The detection electrode 102 has two linear parts 102A that extend linearly in the front-rear direction (Y-axis direction), and one connecting part 102B that extends linearly in the left-right direction (X-axis direction) and connects the ends of the two linear parts 102A on the rear side (the negative side on the Y-axis). Thus, the detection electrode 102 is formed in a letter-U shape in a plan view viewed from above (from the positive side on the Z-axis). The first side shield electrode 103 and the side ground electrode 104 are disposed between the two linear parts 102A of the detection electrode 102. That is, the two linear parts 102A of the detection electrode 102 are disposed parallel with two linear parts 103A of the first side shield electrode 103 and the side ground electrode 104. The detection electrode 102 is connected to the detection circuit 120. The detection electrode 102 is driven by a first alternating-current (AC) drive voltage V1 being applied from the detection circuit 120.

The first side shield electrode 103 is a thin film-like electrode composed of a conductive material, such as a metal, inorganic conductive oxide, conductive resin, and the like and provided on the upper surface 101A of the substrate 101. The first side shield electrode 103 has two linear parts 103A that extend linearly in the front-rear direction (Y-axis direction), and one connecting part 103B that extends linearly in the left-right direction (X-axis direction) and connects the ends of the two linear parts 103A on the rear side (the negative side on the Y-axis). Thus, the first side shield electrode 103 is formed in a letter-U shape in a plan view viewed from above (from the positive side on the Z-axis). The first side shield electrode 103 is provided between (i.e., within) the two linear parts 102A of the detection electrode 102 in the width direction (X-axis direction) of the capacitance sensor 100. The side ground electrode 104 is disposed between the two linear parts 103A of the first side shield electrode 103. That is, the two linear parts 103A of the first side shield electrode 103 are disposed parallel with the two linear parts 102A of the detection electrode 102 and the side ground electrode 104. The first side shield electrode 103 is electrically connected to the detection circuit 120. The first side shield electrode 103 is driven by a second AC drive voltage V2 being applied from the detection circuit 120. The second AC drive voltage V2 has the same frequency and the same phase as those of the first AC drive voltage V1 applied to the detection electrode 102.

The side ground electrode 104 is a thin film-like electrode composed of a conductive material, such as a metal, inorganic conductive oxide, conductive resin, and the like and provided on the upper surface 101A of the substrate 101. The side ground electrode 104 has a strip shape that extends linearly in the front-rear direction (Y-axis direction) on the upper surface 101A of the substrate 101. The side ground electrode 104 is connected to the ground potential of the circuit board 11 as the detection circuit 120 is. In the example shown in FIGS. 2 and 3, the side ground electrode 104 is provided in the center of the capacitance sensor 100 in the width direction (X-axis direction), that is, it is provided between the two linear parts 103A of the first side shield electrode 103. Thus, the side ground electrode 104 is provided parallel with the two linear parts 103A of the first side shield electrode 103 and the two linear parts 102A of the detection electrode 102.

The back shield electrode 106 is a thin film-like electrode composed of a conductive material, such as a metal, inorganic conductive oxide, conductive resin, and the like and provided on a lower surface 101B (an example of the “other surface”) of the substrate 101. The back shield electrode 106 has the same (i.e. rectangular) shape as that of the lower surface 101B of the substrate 101 in a plan view viewed from above (from the positive side on the Z-axis) to cover the entirety of the lower surface 101B of the substrate 101. The back shield electrode 106 is disposed to face the detection electrode 102 through the substrate 101. The back shield electrode 106 is electrically connected to the detection circuit 120. The back shield electrode 106 is driven by the second AC drive voltage V2 being applied from the detection circuit 120. The back shield electrode 106 and the first side shield electrode 103 are electrically connected. As a result, the second AC drive voltage V2 having the same frequency and the same phase is applied to both the back shield electrode 106 and the first side shield electrode 103 from the detection circuit 120.

The cover 107 is an insulating member that is provided on the uppermost surface and covers the upper surface 101A of the substrate 101 and the respective electrodes (the detection electrode 102, the first side shield electrode 103, and the side ground electrode 104). The cover 107 has the same (i.e. rectangular) shape as that of the upper surface 101A of the substrate 101 in a plan view viewed from above (from the positive side on the Z-axis) to cover the entirety of the upper surface 101A of the substrate 101. The cover 107 is formed in the shape of a film or a plate thicker than a film, composed of, for example, a resin material, such as a photosensitive resist, such as polyethylene terephthalate (PET), polymethyl methacrylate (PMMA), novolac resin, and the like, or a glass material.

### (Parasitic Capacitances Generated in Capacitance Sensor 100)

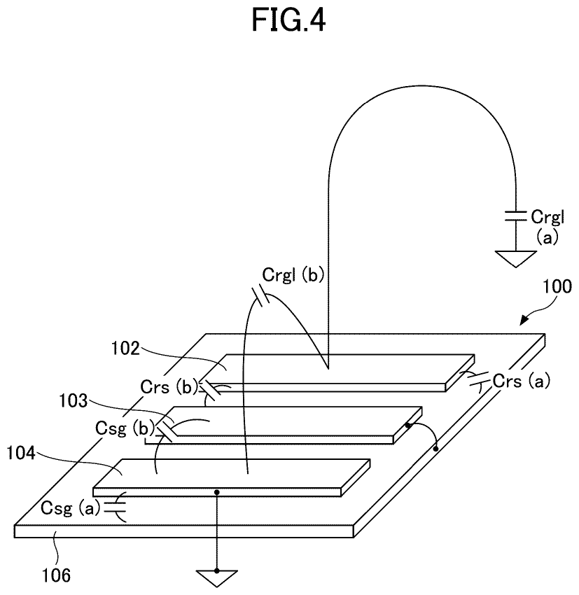

FIG. 4 is a diagram showing a parasitic capacitance generated in the capacitance sensor 100 according to the first embodiment. Further, FIG. 4 is a schematic extractive conceptual diagram showing each electrode provided on one side (on the positive side or the negative side on the X-axis) in the width direction, of the side ground electrode 104 provided in the center in the width direction (the X-axis direction) in FIGS. 2 and 3. As shown in FIG. 4, the following parasitic capacitances are generated in the capacitance sensor 100 according to the first embodiment. The first side shield electrode 103 is electrically connected to the back shield electrode 106. The side ground electrode 104 is connected to the ground potential of the circuit board 11 as the detection circuit 120 is.
Parasitic capacitance between the detection electrode 102 and the ground potential: Crgl(a)
Parasitic capacitance between the detection electrode 102 and the side ground electrode 104: Crgl(b)
Parasitic capacitance between the detection electrode 102 and the back shield electrode 106: Crs(a)
Parasitic capacitance between the detection electrode 102 and the first side shield electrode 103: Crs(b)
Parasitic capacitance between the side ground electrode 104 and the back shield electrode 106: Csg(a)
Parasitic capacitance between the side ground electrode 104 and the first side shield electrode 103: Csg(b)

### (Circuit Model of Capacitance Detection Device 10)

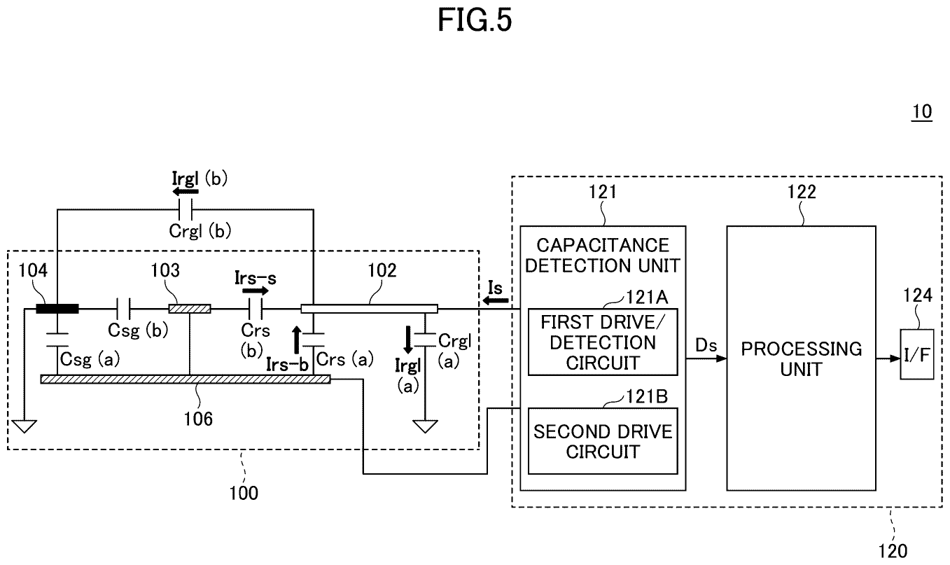

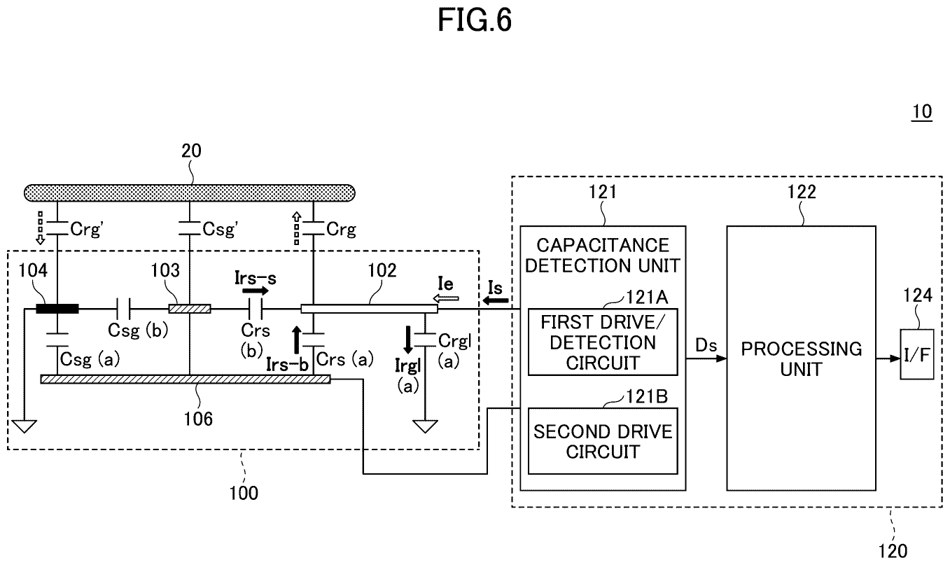

FIG. 5 is a diagram showing a circuit model of the capacitance detection device 10 according to the first embodiment (when a detection target 20 is not present on the capacitance sensor 100). FIG. 6 is a diagram showing a circuit model of the capacitance detection device 10 according to the first embodiment (when a detection target 20 is present on the capacitance sensor 100).

As shown in FIGS. 5 and 6, the detection circuit 120 includes a capacitance detection unit 121, a processing unit 122, and an interface (I/F) 124.

The capacitance detection unit 121 is electrically connected to the detection electrode 102, the first side shield electrode 103, and the back shield electrode 106. The first side shield electrode 103 and the back shield electrode 106 are electrically connected to each other.

The capacitance detection unit 121 includes a first drive/detection circuit 121A and a second drive circuit 121B. The first drive/detection circuit 121A generates the first AC drive voltage V1 and applies the first AC drive voltage V1 to the detection electrode 102. The first drive/detection circuit 121A detects a change Ie in a current Is flowing through the detection electrode 102 as a change in the capacitance in the detection electrode 102, and outputs a detection signal Ds based on the change Ie in the current Is. The second drive circuit 121B generates the second AC drive voltage V2 having the same frequency and the same phase as those of the first AC drive voltage V1, and applies the second AC drive voltage V2 to the first side shield electrode 103 and the back shield electrode 106.

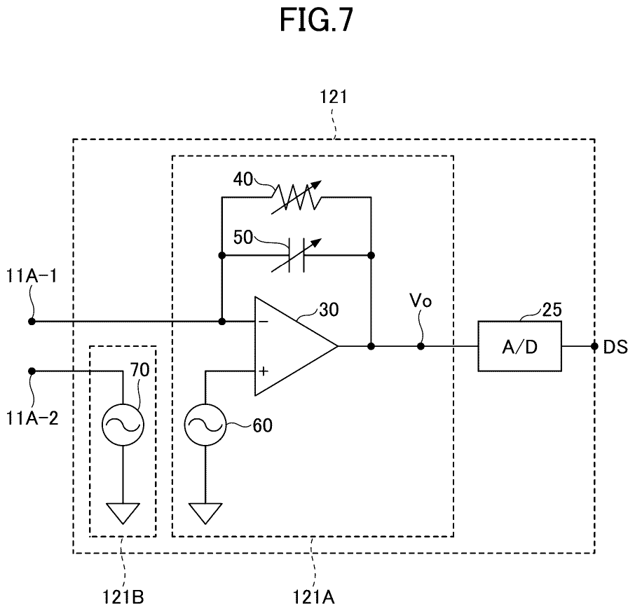

FIG. 7 is a diagram showing an example of the circuit configuration of the capacitance detection unit 121 included in the capacitance detection device 10 according to the first embodiment. For example, as shown in FIG. 7, the capacitance detection unit 121 includes the first drive/detection circuit 121A, the second drive circuit 121B, and an A/D converter 25.

The first drive/detection circuit 121A is electrically connected to the detection electrode 102 via a lead wire 11A-1. The first drive/detection circuit 121A includes an operational amplifier 30, a feedback resistor 40, a feedback capacitor 50, and a first AC voltage circuit 60 serving as a first AC power source.

The first AC voltage circuit 60 generates the first AC drive voltage V1, and applies the first AC drive voltage V1 to a non-inverting input terminal (+) of the operational amplifier 30.

The detection electrode 102 is connected to an inverting input terminal (−) of the operational amplifier 30 via the lead wire 11A-1, and the first AC voltage circuit 60 is connected to the non-inverting input terminal (+) of the operational amplifier 30. The operational amplifier 30 amplifies the voltage difference between the inverting input terminal (−) connected to the detection electrode 102 and the non-inverting input terminal (+) to which the first AC drive voltage V1 is applied, and outputs it as an output voltage Vo. The feedback resistor 40 and the feedback capacitor 50 are connected in parallel between the output terminal and the inverting input terminal (−) of the operational amplifier 30, thereby applying negative feedback. The resistance value of the feedback resistor 40 is variable. The capacitance value of the feedback capacitor 50 is adjustable. The operational amplifier 30 outputs a change in the capacitance in the detection electrode 102 as the output voltage Vo based on the change Ie in the current Is flowing through the detection electrode 102. The output voltage Vo is converted into the detection signal Ds by the A/D converter 25.

The second drive circuit 121B includes a second AC voltage circuit 70 serving as a second AC power source. The second AC voltage circuit 70 is electrically connected to the first side shield electrode 103 and the back shield electrode 106 via a lead wire 11A-2. The second drive circuit 121B generates the second AC drive voltage V2 having the same frequency and the same phase as those of the first AC drive voltage V1 by the second AC voltage circuit 70.

In the detection circuit 120 according to the first embodiment, it is preferable that the amplitude of the second AC drive voltage V2 output from the second drive circuit 121B is greater than the amplitude of the first AC drive voltage V1 output from the first drive/detection circuit 121A. Thus, the detection circuit 120 according to the first embodiment can effectively reduce the parasitic capacitances Crgl(Crgl(a)+Crgl(b)) between the detection electrode 102 and the ground potential and side ground electrode 104 by the parasitic capacitances Crs (Crs(a)+Crs(b)) generated between the detection electrode 102 and the first side shield electrode 103 and back shield electrode 106, and can obtain a detection signal having a high signal-to-noise (SN) ratio by means of the detection electrode 102. Furthermore, it is possible to prevent saturation of the output voltage Vo from the operational amplifier 30, and to increase the dynamic range of the output voltage Vo.

The processing unit 122 executes various predetermined processes based on the detection signal Ds output from the capacitance detection unit 121. For example, based on the detection signal Ds, the processing unit 122 executes predetermined processes, such as determination of whether or not a detection target 20 is present on the capacitance sensor 100, determination of the number of detection targets 20 present on the capacitance sensor 100, and the like. For example, the processing unit 122 includes a processor (for example, a central processing unit (CPU)), a memory (for example, random access memory (RAM)), and the like, and executes various predetermined processes by the processor executing a program stored in the memory. For example, an Integrated Circuit (IC) is used as the processing unit 122.

The I/F 124 outputs data indicating the results of execution of the predetermined processes by the processing unit 122 (for example, the presence or absence of a detection target 20 on the capacitance sensor 100, the number of detection targets 20 present on the capacitance sensor 100, and the like) to another device that uses the data.

### (Detection Operation of Capacitance Sensor 100)

In the capacitance sensor 100 according to the first embodiment configured as described above, the detection electrode 102 is driven by the first AC drive voltage V1 supplied from the detection circuit 120. Thus, in the capacitance sensor 100 according to the first embodiment, when the mounting state of the detection target 20 on the capacitance sensor 100 changes, the capacitance (Crg+Crg′) of the detection target 20 detected by the detection electrode 102 changes. Therefore, the detection circuit 120 according to the first embodiment can determine the mounting state of the detection target 20 on the capacitance sensor 100 (the presence or absence of a detection target 20, the number of detection targets 20, and the like) based on the capacitance (Crg+Crg′) of the detection target 20 detected by the detection electrode 102.

The capacitance sensor 100 according to the first embodiment includes the first side shield electrode 103 disposed parallel with the detection electrode 102 on the upper surface 101A of the substrate 101, and the first side shield electrode 103 is driven by the second AC drive voltage V2 having the same frequency and the phase as those of the first AC drive voltage V1 applied to the detection electrode 102. The capacitance sensor 100 according to the first embodiment includes the back shield electrode 106 provided on the lower surface 101B of the substrate 101 to face the detection electrode 102, and the back shield electrode 106 is driven by the second AC drive voltage V2 having the same frequency and the phase as those of the first AC drive voltage V1 applied to the detection electrode 102. Thus, in the capacitance sensor 100 according to the first embodiment, as shown in FIGS. 5 and 6, the sum of the current Irgl(b) flowing through the parasitic capacitance Crgl(b) between the detection electrode 102 and the side ground electrode 104 and the current Irgl(a) flowing through the parasitic capacitance Crgl(a) between the detection electrode 102 and the ground potential is offset by the sum of the current Irs-s flowing through the parasitic capacitance Crs(b) between the first side shield electrode 103 and the detection electrode 102 and the current Irs-b flowing through the parasitic capacitance Crs(a) between the back shield electrode 106 and the detection electrode 102. This is because the capacitance detection unit 121 (the first drive/detection circuit 121A) adjusts the amplitude of the first AC drive voltage V1 applied to the detection electrode 102 to be smaller than the amplitude of the second AC drive voltage such that the sum of the current Irs-b and the current Irs-s flowing into the detection electrode 102 from the back shield electrode 106 and the first side shield electrode 103 to which the second AC drive voltage V2 is applied becomes equal to the sum of the current Irgl(a) and the current Irgl(b) flowing out from the detection electrode 102. Therefore, the capacitance sensor 100 according to the first embodiment can reduce the sum of the parasitic capacitance Crgl(b) between the detection electrode 102 and the side ground electrode 104 and the parasitic capacitance Crgl(a) between the detection electrode 102 and the ground potential by the sum of the parasitic capacitance Crs(b) between the first side shield electrode 103 and the detection electrode 102 and the parasitic capacitance Crs(a) between the back shield electrode 106 and the detection electrode 102.

As described above, the capacitance sensor 100 according to the first embodiment can reduce the parasitic capacitances Crgl(Crgl(a)+Crgl(b)) generated between the detection electrode 102 and the ground potential and side ground electrode 104 by the parasitic capacitances (Crs(a)+Crs(b)) of the first side shield electrode 103 and the back shield electrode 106 in a state where no detection target 20 is present on the capacitance sensor 100 as shown in FIG. 5. As shown in FIG. 6, in a state where a detection target 20 is present on the capacitance sensor 100, the capacitance detected by the detection electrode 102 becomes a capacitance from which the parasitic capacitances Crgl are eliminated, and substantially becomes the capacitance (Crg+Crg′) of the detection target 20. Therefore, the detection accuracy of the detection target 20 by the detection electrode 102 can be improved. The capacitance (Crg+Crg′) of the detection target 20 detected by the detection electrode 102 is detected by the first drive/detection circuit 121A as the change Ie in the current Is.

In the capacitance sensor 100 according to the first embodiment, as shown in FIG. 6, when a detection target 20 is present, a capacitance Crg is generated between the detection electrode 102 and the detection target 20, and a capacitance Crg′ is generated between the detection target 20 and the side ground electrode 104. Therefore, in the capacitance sensor 100 according to the first embodiment, when the detection target 20 is present, the capacitance of the detection target 20 detected by the detection electrode 102 is amplified to the sum of the capacitance Crg and the capacitance Crg′, making it possible to enhance the detection accuracy of the detection target 20 by the detection electrode 102.

As described above, the capacitance sensor 100 according to the first embodiment includes the substrate 101, the detection electrode 102 disposed on one surface of the substrate 101, the first side shield electrode 103 disposed parallel with the detection electrode 102 on one surface of the substrate 101, and the back shield electrode 106 disposed on the other surface of the substrate 101 to face the detection electrode 102 through the substrate 101. The first AC drive voltage V1 is applied to the detection electrode 102, the second AC drive voltage V2 having the same frequency and the same phase as those of the first AC drive voltage V1 is applied to the first side shield electrode 103 and the back shield electrode 106, and the capacitance sensor 100 further includes the side ground electrode 104 that is disposed parallel with the detection electrode 102 and the first side shield electrode 103 on the one surface of the substrate 101, and is connected to the ground potential.

Thus, the capacitance sensor 100 according to the first embodiment can reduce the respective parasitic capacitances (the parasitic capacitance between the detection electrode 102 and the back shield electrode 106, the parasitic capacitance between the detection electrode 102 and the ground potential, the parasitic capacitance between the detection electrode 102 and the first side shield electrode 103, and the parasitic capacitance between the detection electrode 102 and the side ground electrode 104) by means of the first side shield electrode 103 and the back shield electrode 106 even when the conductivity or the dielectric constant of the detection target 20 present on the one surface side of the substrate 101 is low. The capacitance sensor 100 according to the first embodiment can amplify the capacitance of the detection target 20 detected by the detection electrode 102 to the sum of the capacitance between the detection electrode 102 and the detection target 20 and the capacitance between the detection target 20 and the side ground electrode 104. Therefore, the capacitance sensor 100 according to the first embodiment can detect the detection target 20 having a low conductivity or a low dielectric constant with a high sensitivity.

In the capacitance sensor 100 according to the first embodiment, the first side shield electrode 103 is disposed between the detection electrode 102 and the side ground electrode 104.

Thus, the capacitance sensor 100 according to the first embodiment can increase the sensitivity of the detection circuit 120 by bringing about a state in which the respective parasitic capacitances mentioned above are reduced, and can detect even a minute change in the capacitance between the detection electrode 102 and the side ground electrode 104. Thus, the capacitance sensor 100 according to the first embodiment can detect even a detection target 20 having a low dielectric constant, based on any change in the capacitance between the detection electrode 102 and the side ground electrode 104.

Further, in the capacitance sensor 100 according to the first embodiment, the detection electrode 102, the side ground electrode 104, and the first side shield electrode 103 have a longer direction in the first direction (Y-axis direction), and the connection part 100A for connection to the lead wire 11A that is provided at one end in the first direction (the end on the positive side on the Y-axis) is further provided. The first side shield electrode 103 includes the two linear parts 103A disposed parallel with the side ground electrode 104, and the connecting part 103B that connects the two linear parts 103A with each other at the other end in the first direction (at the end on the negative side on the Y-axis). The detection electrode 102 includes the two linear parts 102A disposed parallel with the side ground electrode 104, and the connecting part 102B that connects the two linear parts 102A with each other at the other end in the first direction (at the end on the negative side on the Y-axis).

As a result, the capacitance sensor 100 according to the first embodiment can do without forming the lead wires 11A to be lead into and gathered in the detection region, which is done in a mutual capacitance-type capacitance sensor in which the drive electrode and the detection electrode are disposed to cross in the front-rear direction (Y-axis direction) and the width direction (X-axis direction). Thus, it is possible to eliminate occurrence of any parasitic capacitance and noise on the lead wires 11A in the detection region. Thus, it is possible to expand the detection region while securing a high detection sensitivity and a high SN ratio.

Furthermore, the capacitance sensor 100 according to the first embodiment can prevent a phase shift of the first AC drive voltage V1 applied to the linear parts 102A of the detection electrode 102 and a phase shift of the second AC drive voltage V2 applied to the linear parts 103A of the first side shield electrode 103 and can guarantee that the first AC drive voltage V1 and the second AC drive voltage V2 are at the same phase. This makes it possible to reduce the parasitic capacitances and stably secure a high SN ratio of the detection signal.

### Second Embodiment

Next, a second embodiment will be described. A capacitance detection device 10-2 according to the second embodiment is different from the capacitance detection device 10 according to the first embodiment in that it includes a capacitance sensor 100-2 instead of the capacitance sensor 100.

### (Configuration of Capacitance Sensor 100-2)

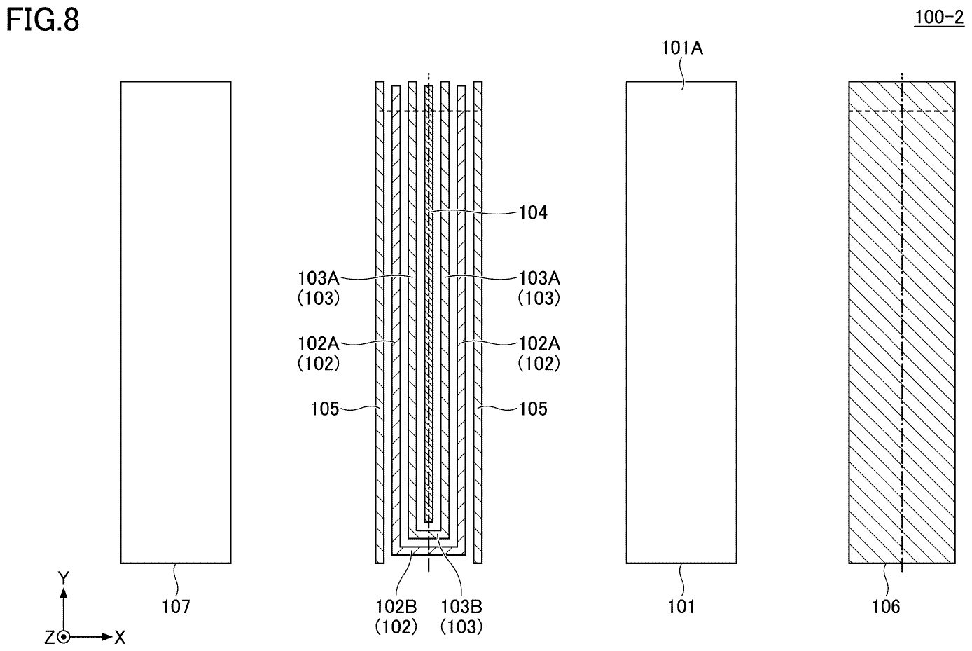

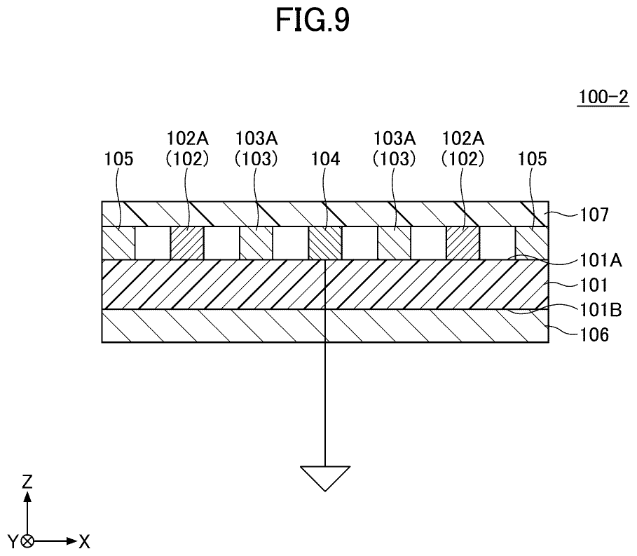

FIG. 8 is an exploded plan view of the capacitance sensor 100-2 according to the second embodiment. FIG. 9 is a cross-sectional view of the capacitance sensor 100-2 according to the second embodiment.

As shown in FIGS. 8 and 9, the capacitance sensor 100-2 according to the second embodiment is different from the capacitance sensor 100 according to the first embodiment in that it further includes a second side shield electrode 105.

The second side shield electrode 105 is a thin film-like electrode composed of a conductive material, such as metal, inorganic conductive oxide, conductive resin, and the like and provided on the upper surface 101A of the substrate 101. The second side shield electrode 105 has a strip shape that extends linearly in the front-rear direction (Y-axis direction) on the upper surface 101A of the substrate 101. As shown in FIGS. 8 and 9, the capacitance sensor 100-2 according to the second embodiment includes two second side shield electrodes 105. The two second side shield electrodes 105 are provided on the outer side of the two linear parts 102A of the detection electrode 102 in the width direction (X-axis direction) of the capacitance sensor 100. That is, the two second side shield electrodes 105 are provided on the outermost side in the width direction (X-axis direction) of the capacitance sensor 100. The detection electrode 102, the first side shield electrode 103, and the side ground electrode 104 are provided between the two second side shield electrodes 105. Further, the two second side shield electrodes 105 are disposed parallel with the two linear parts 102A of the detection electrode 102, the two linear parts 103A of the first side shield electrode 103, and the side ground electrode 104. The two second side shield electrodes 105 are electrically connected to the detection circuit 120. The two second side shield electrodes 105 are driven by the second AC drive voltage V2 being applied from the detection circuit 120. The second side shield electrodes 105 and the first side shield electrode 103 are electrically connected to the back shield electrode 106. Thus, the second AC drive voltage V2 having the same frequency and the same phase is applied to the second side shield electrodes 105, the back shield electrode 106, and the first side shield electrode 103 from the detection circuit 120.

Further, in the capacitance sensor 100-2, although the two second side shield electrodes 105 are formed in the strip shape on the outermost side in the width direction (X-axis direction), the second side shield electrodes 105 may be formed in a letter-U shape in a plan view viewed from above (from the positive side on the Z-axis), with formation of one connecting part 105B (not shown) that connects the ends of the two second side shield electrodes 105 with each other on the rear side (on the negative side on the Y-axis).

As a result, the capacitance sensor 100-2 according to the second embodiment can prevent a phase shift of the second AC drive voltage V2 applied to the two second side shield electrodes 105 and guarantee that the second AC drive voltage V2 applied to the two second side shield electrodes 105 are at the same phase. This makes it possible to reduce the parasitic capacitances and stably secure a high SN ratio of the detection signal.

### (Parasitic Capacitances Generated in Capacitance Sensor 100-2)

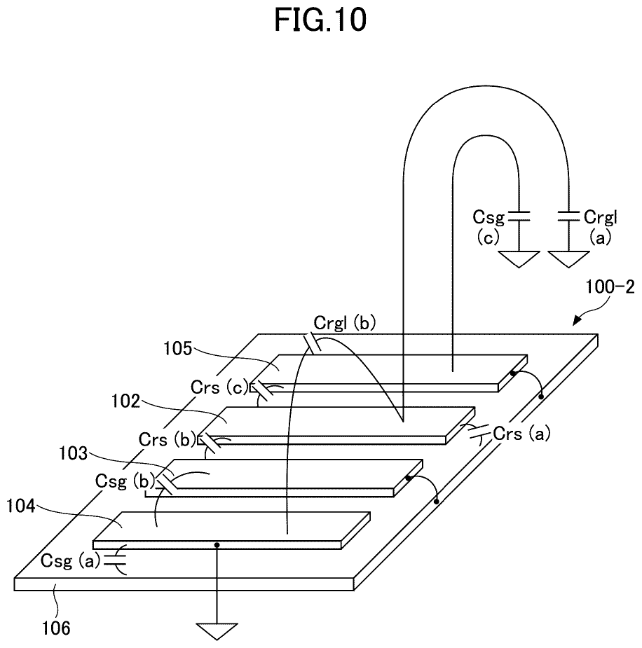

FIG. 10 is a diagram showing parasitic capacitances generated in the capacitance sensor 100-2 according to the second embodiment. FIG. 10 is a schematic extractive conceptual diagram showing each electrode on one side (on the positive side or the negative side on the X-axis) in the width direction, of the side ground electrode 104 provided in the center in the width direction (the X-axis direction) in FIGS. 8 and 9. As shown in FIG. 10, in the capacitance sensor 100-2 according to the second embodiment, the following parasitic capacitances are generated. The first side shield electrode 103 and the second side shield electrode 105 are electrically connected to the back shield electrode 106. The side ground electrode 104 is connected to the ground potential of the circuit board 11 as the detection circuit 120 is.
Parasitic capacitance between the detection electrode 102 and the ground potential: Crgl(a)
Parasitic capacitance between the detection electrode 102 and the side ground electrode 104: Crgl(b)
Parasitic capacitance between the detection electrode 102 and the back shield electrode 106: Crs(a)
Parasitic capacitance between the detection electrode 102 and the first side shield electrode 103: Crs(b)
Parasitic capacitance between the detection electrode 102 and the second side shield electrode 105: Crs(c)
Parasitic capacitance between the side ground electrode 104 and the back shield electrode 106: Csg(a)
Parasitic capacitance between the side ground electrode 104 and the first side shield electrode 103: Csg(b)
Parasitic capacitance between the second side shield electrode 105 and the ground potential: Csg(c)

### (Circuit Model of Capacitance Detection Device 10-2)

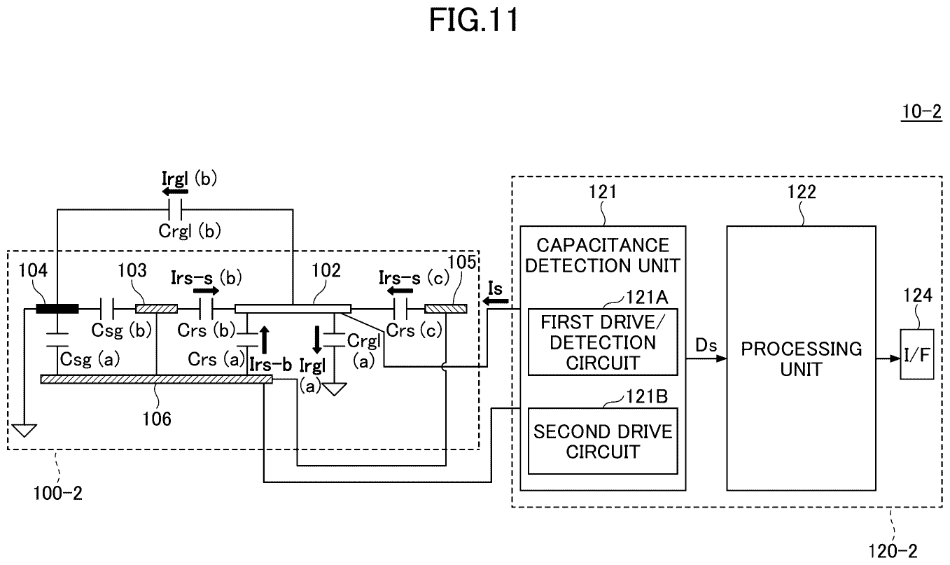

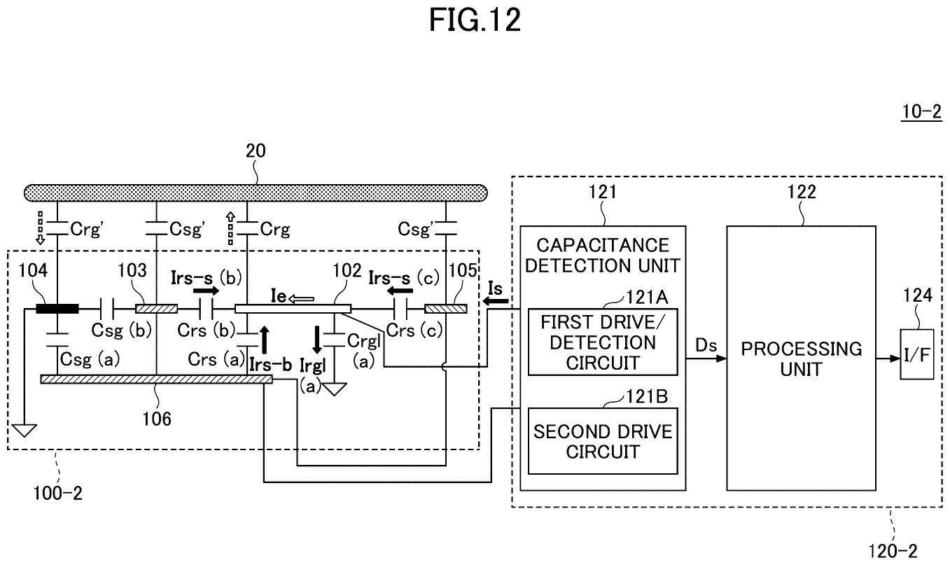

FIG. 11 is a diagram showing a circuit model of the capacitance detection device 10-2 according to the second embodiment (when a detection target 20 is not present on the capacitance sensor 100-2). FIG. 12 is a diagram showing a circuit model of the capacitance detection device 10-2 according to the second embodiment (when a detection target 20 is present on the capacitance sensor 100-2).

As shown in FIGS. 11 and 12, a detection circuit 120-2 provided in the capacitance detection device 10-2 according to the second embodiment is the same as the detection circuit 120 according to the first embodiment. The capacitance sensor 100-2 differs from the circuit model of the capacitance detection device 10 according to the first embodiment in that the back shield electrode 106 is electrically connected to the second side shield electrode 105, and the second side shield electrode 105 is electrically connected to the capacitance detection unit 121. The capacitance detection unit 121 of the detection circuit 120-2 generates the second AC drive voltage V2 having the same frequency and the same phase as those of the first AC drive voltage V1, and applies the second AC drive voltage V2 to the first side shield electrode 103, the second side shield electrode 105, and the back shield electrode 106. Specifically, the second AC voltage circuit 70, which is the second AC power source of the second drive circuit 121B shown in FIG. 7, generates the second AC drive voltage V2 having the same frequency and the same phase as those of the first AC drive voltage V1, and applies the second AC drive voltage V2 to the first side shield electrode 103, the second side shield electrode 105, and the back shield electrode 106 through the lead wire 11A-2.

### (Detection Operation of Capacitance Sensor 100-2)

Like the capacitance sensor 100 according to the first embodiment, the capacitance sensor 100-2 according to the second embodiment configured as described above can detect the capacitance (Crg+Crg′) of the detection target 20 by means of the detection electrode 102. The detection circuit 120-2 according to the second embodiment can determine the mounting state of the detection target 20 on the capacitance sensor 100-2 (the presence or absence of a detection target 20, the number of detection targets 20, and the like) based on the capacitance (Crg+Crg′) of the detection target 20 detected by the detection electrode 102.

Here, the capacitance sensor 100-2 according to the second embodiment includes the first side shield electrode 103 and the second side shield electrode 105 that are disposed parallel with the detection electrode 102 on the upper surface 101A of the substrate 101, and the first side shield electrode 103 and the second side shield electrode 105 are driven by the second AC drive voltage V2 having the same frequency and the same phase as those of the first AC drive voltage V1 applied to the detection electrode 102. The capacitance sensor 100-2 according to the second embodiment includes back shield electrode 106 provided on the lower surface 101B of the substrate 101 to face the detection electrode 102, and the back shield electrode 106 is driven by the second AC drive voltage V2 having the same frequency and the same phase as those of the first AC drive voltage V1 applied to the detection electrode 102.

Thus, in the capacitance sensor 100-2 according to the second embodiment, as shown in FIGS. 11 and 12, the sum of the current Irgl(b) flowing through the parasitic capacitance Crgl(b) between the detection electrode 102 and the side ground electrode 104 and the current Irgl(a) flowing through the parasitic capacitance Crgl(a) between the detection electrode 102 and the ground potential is offset by the sum of the current Irs-s(b) flowing through the parasitic capacitance Crs(b) between the first side shield electrode 103 and the detection electrode 102, the current Irs-s(c) flowing through the parasitic capacitance Crs(c) between the second side shield electrode 105 and the detection electrode 102, and the current Irs-b flowing through the parasitic capacitance Crs(a) between the back shield electrode 106 and the detection electrode 102.

This is because, in FIG. 11, the capacitance detection unit 121 (the first drive/detection circuit 121A) adjusts the amplitude of the first AC drive voltage V1 applied to the detection electrode 102 to be smaller than the amplitude of the second AC drive voltage such that the sum of the current Irs-b, the current Irs-s(b), and the current Irs-s(c) flowing into the detection electrode 102 from the back shield electrode 106, the first side shield electrode 103, and the second side shield electrode 105 to which the second AC drive voltage V2 is applied becomes equal to the sum of the current Irgl(a) and the current Irgl(b) flowing out of the detection electrode 102.

Therefore, the capacitance sensor 100-2 according to the second embodiment can reduce the sum of the parasitic capacitance Crgl(b) between the detection electrode 102 and the side ground electrode 104 and the parasitic capacitance Crgl(a) between the detection electrode 102 and the ground potential by the sum of the parasitic capacitance Crs(b) between the first side shield electrode 103 and the detection electrode 102, the parasitic capacitance Crs(c) between the second side shield electrode 105 and the detection electrode 102, and the parasitic capacitance Crs(a) between the back shield electrode 106 and the detection electrode 102.

Therefore, by means of the parasitic capacitance Crs(c) between the second side shield electrode 105 and the detection electrode 102, the capacitance sensor 100-2 according to the second embodiment can cause the currents (Irs-b, Irs-s(b), and Irs-s(c)) to flow through the parasitic capacitances, Crs(a), Crs(b) and Crs(c) between the detection electrode 102 and the respective shields at more effectively divided terms of a ratio than those in the capacitance sensor 100 according to the first embodiment, and can efficiently reduce the imbalance between the terms of the ratio at which the parasitic capacitances Crgl(a) and Crgl(b) of the detection electrode 102 are reduced. In particular, the capacitance sensor 100-2 according to the second embodiment can increase the term of the ratio at which the parasitic capacitance Crgl(a) between the detection electrode 102 and the ground potential is reduced, and can efficiently and substantially achieve a high SN ratio of the detection signal.

Furthermore, since the second side shield electrode 105 is provided parallel with the detection electrode 102 on the outer side (in the X-axis direction), the capacitance sensor 100-2 according to the second embodiment can prevent an external noise, which is from the outer side in the width direction (the X-axis direction) of the capacitance sensor 100-2, from flowing into the detection electrode 102, by means of the second side shield electrode 105 to which the second AC drive voltage V2 is applied. Thus, the capacitance sensor 100-2 according to the second embodiment can improve the external noise resistance. Therefore, the capacitance sensor 100-2 according to the second embodiment can improve the stability of the high SN ratio of the detection signal better than the capacitance sensor 100 according to the first embodiment.

As described above, the capacitance sensor 100-2 according to the second embodiment can reduce the parasitic capacitances Crgl(Crgl(a)+Crgl(b)) generated between the detection electrode 102 and the ground potential and side ground electrode 104 by the parasitic capacitances (Crs(a)+Crs(b)+Crs(c)) of the first side shield electrode 103, the second side shield electrode 105, and the back shield electrode 106 when no detection target 20 is present on the capacitance sensor 100-2 as shown in FIG. 11. When a detection target 20 is present on the capacitance sensor 100-2 as shown in FIG. 12, the capacitance detected by the detection electrode 102 becomes a capacitance from which the parasitic capacitances Crgl are eliminated, and substantially becomes the capacitance (Crg+Crg′) of the detection target 20. Therefore, the capacitance sensor 100-2 according to the second embodiment can improve the detection accuracy of the detection target 20 by the detection electrode 102. The capacitance (Crg+Crg′) of the detection target 20 detected by the detection electrode 102 is detected by the first drive/detection circuit 121A as the change Ie in the current Is.

In the capacitance sensor 100-2 according to the second embodiment, as shown in FIG. 12, when the detection target 20 is present, the capacitance Crg is generated between the detection electrode 102 and the detection target 20, and the capacitance Crg′ is generated between the detection target 20 and the side ground electrode 104. Therefore, in the capacitance sensor 100-2 according to the second embodiment, when the detection target 20 is present, the capacitance of the detection target 20 detected by the detection electrode 102 is amplified to the sum of the capacitance Crg and the capacitance Crg′. Therefore, the detection accuracy of the detection target 20 by the detection electrode 102 can be improved.

### (Example of How Detection Target 20 is Detected by Capacitance Sensor 100-2)

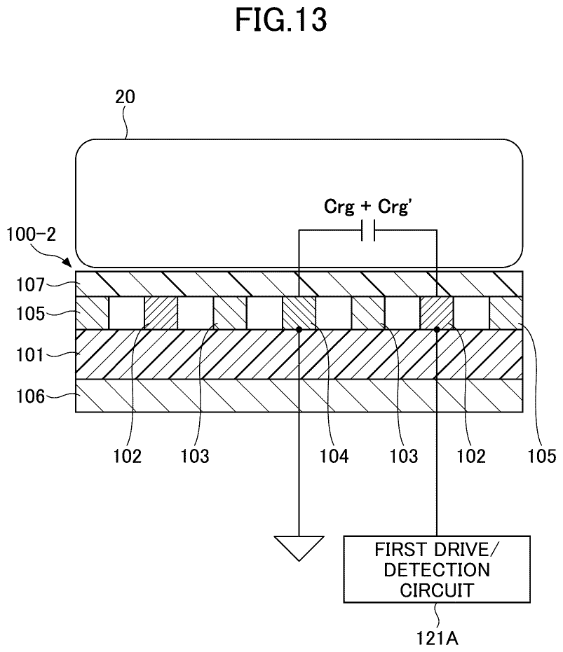

FIG. 13 is a diagram showing an example of how the detection target 20 is detected by the capacitance sensor 100-2 according to the second embodiment.

As shown in FIG. 13, the detection target 20 is mounted on the capacitance sensor 100-2 according to the second embodiment, straddling from the detection electrode 102, to which the first AC drive voltage V1 is applied by the first drive/detection circuit 121A to the side ground electrode 104 connected to the ground potential. Therefore, the substantial capacitance of the detection target 20 detected by the detection electrode 102 connected to the first drive/detection circuit 121A is the sum of the capacitance Crg between the detection electrode 102 and the detection target 20 and the capacitance Crg′ between the detection target 20 and the side ground electrode 104. Therefore, the capacitance sensor 100-2 according to the second embodiment can detect the detection target 20 with a high sensitivity by means of the detection electrode 102.

In FIG. 13, as the capacitance (Crg+Crg′) of the detection target 20, only the capacitance value between the side ground electrode 104 disposed in the center in the width direction (the X-axis direction) and the detection electrode 102 disposed on the right side thereof (on the positive side on the X-axis) is shown.

As shown in FIG. 13, when the detection target 20 straddles from the side ground electrode 104 in the center in the width direction (the X-axis direction) to both the detection electrode 102 on the right side (on the positive side on the X-axis) and the detection electrode 102 on the left side (on the negative side on the X-axis) in the capacitance sensor 100-2 according to the second embodiment, the capacitance value is approximately two times (Crg+Crg′) because the area over which the detection electrodes 102 face the detection target 20 is approximately two times as large as that over which one detection electrode 102 faces the detection target 20. This is also the case with the capacitance sensor 100 according to the first embodiment.

Further, as shown in FIG. 13, the capacitance sensor 100-2 according to the second embodiment includes the detection electrode 102 on both the right and left sides (the positive side and the negative side in the X-axis direction) of the side ground electrode 104. Therefore, even when the user mounts the detection target 20 on the capacitance sensor 100-2 slid to either one side in the width direction (the X-axis direction) (to the positive side or the negative side on the X-axis), the detection target 20 can be brought to straddlingly face the side ground electrode 104 and the detection electrode 102 on one side provided in the sliding direction, and the capacitance (Crg+Crg′) of the detection target 20 can be detected. Thus, the capacitance sensor 100-2 according to the second embodiment can ensure reliability of detecting the presence or absence of the detection target 20. This is also the case with the capacitance sensor 100 according to the first embodiment.

As described above, the capacitance sensor 100-2 according to the second embodiment further includes the second side shield electrode 105 disposed parallel with the detection electrode 102 on one surface of the substrate 101. The detection electrode 102 is disposed between the first side shield electrode 103 and the second side shield electrode 105, and the second AC drive voltage V2 is applied to the second side shield electrode 105.

Thus, the capacitance sensor 100-2 according to the second embodiment can prevent noise from flowing into the detection electrode 102 from where the second side shield electrode 105 is provided, and can ensure a high detection sensitivity with a high SN ratio. In addition, the capacitance sensor 100-2 according to the second embodiment can cause the currents (Irs-b, Irs-s(b), and Irs-s(c)) to flow through the parasitic capacitances Crs(a), Crs(b), and Crs(c) between the detection electrode 102 and the respective shields at more effectively divided terms of a ratio, and can efficiently reduce the imbalance between the terms of the ratio at which the parasitic capacitances Crgl(a) and Crgl(b) of the detection electrode 102 are reduced. In particular, the capacitance sensor 100-2 according to the second embodiment can increase the term of the ratio at which the parasitic capacitance Crgl(a) between the detection electrode 102 and the ground potential is reduced, and can efficiently and substantially achieve a high SN ratio of the detection signal.

### Third Embodiment

Next, a third embodiment will be described. A capacitance detection device 10-3 according to the third embodiment is different from the capacitance detection device 10-2 according to the second embodiment in that it includes a capacitance sensor 100-3 instead of the capacitance sensor 100-2.

### (Configuration of Capacitance Sensor 100-3)

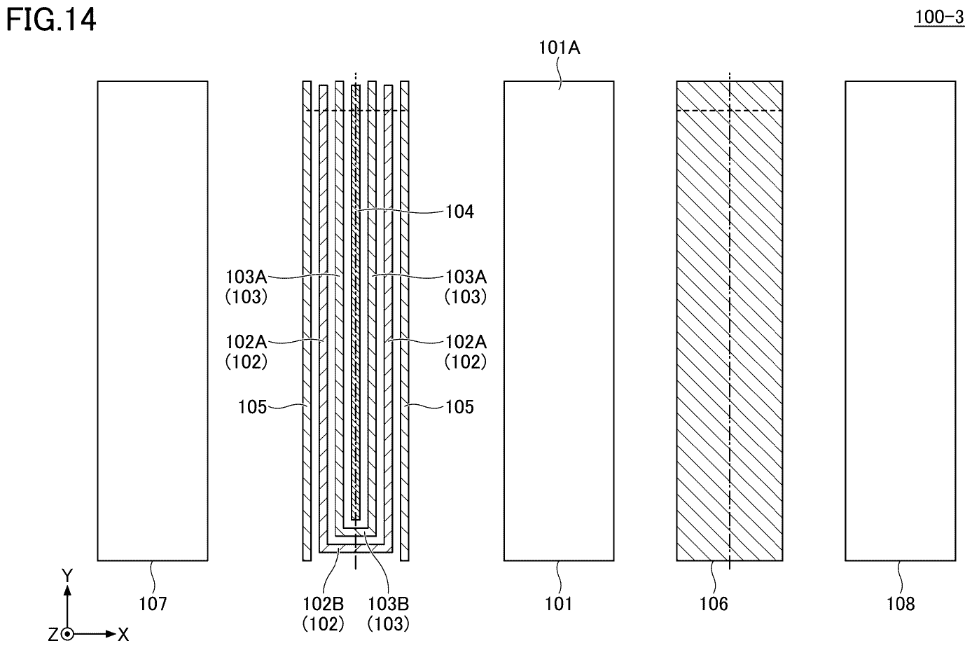

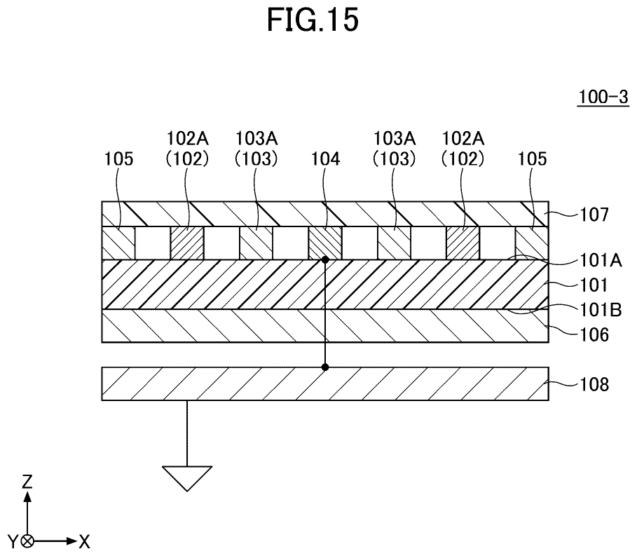

FIG. 14 is an exploded plan view of the capacitance sensor 100-3 according to the third embodiment. FIG. 15 is a cross-sectional view of the capacitance sensor 100-3 according to the third embodiment.

As shown in FIGS. 14 and 15, the capacitance sensor 100-3 according to the third embodiment is different from the capacitance sensor 100-2 according to the second embodiment in that it further includes a back ground electrode 108.

The back ground electrode 108 is a sheet-like or plate-like electrode composed of a conductive material, such as metal, inorganic conductive oxide, conductive resin, and the like, and is provided on the lower side of the back shield electrode 106 (on the negative side on the Z-axis) to be spaced apart from and face the back shield electrode 106. The back ground electrode 108 has the same (i.e., rectangular) shape as that of the back shield electrode 106 in a plan view viewed from above (from the positive side on the Z-axis) to face the entirety of the back shield electrode 106. The back ground electrode 108 has an area (or a volume) greater than that of the side ground electrode 104. The back ground electrode 108 is connected to the ground potential. Therefore, the capacity of the ground potential at the back ground electrode 108 is greater than that at the side ground electrode 104. The back ground electrode 108 is electrically connected to the side ground electrode 104.

### (Circuit Model of Capacitance Detection Device 10-3)

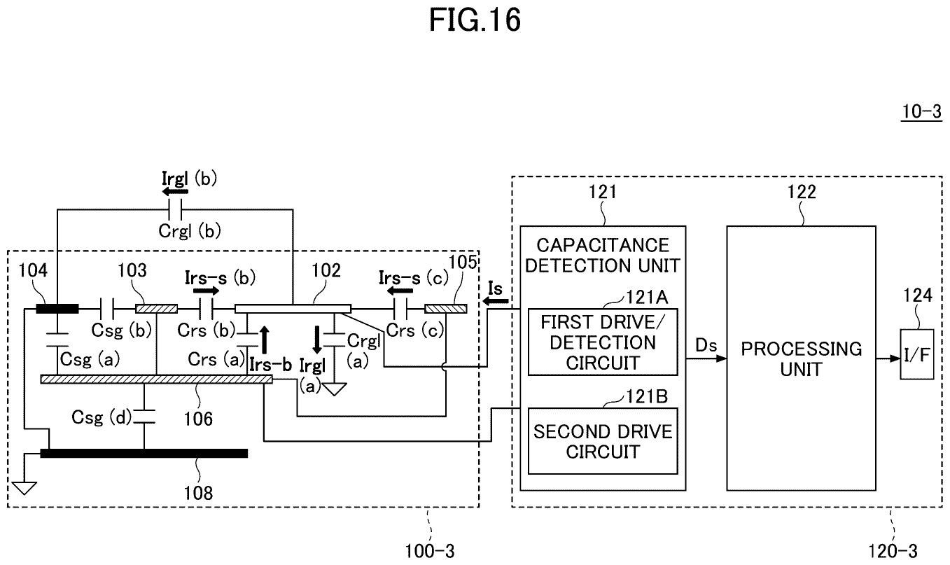

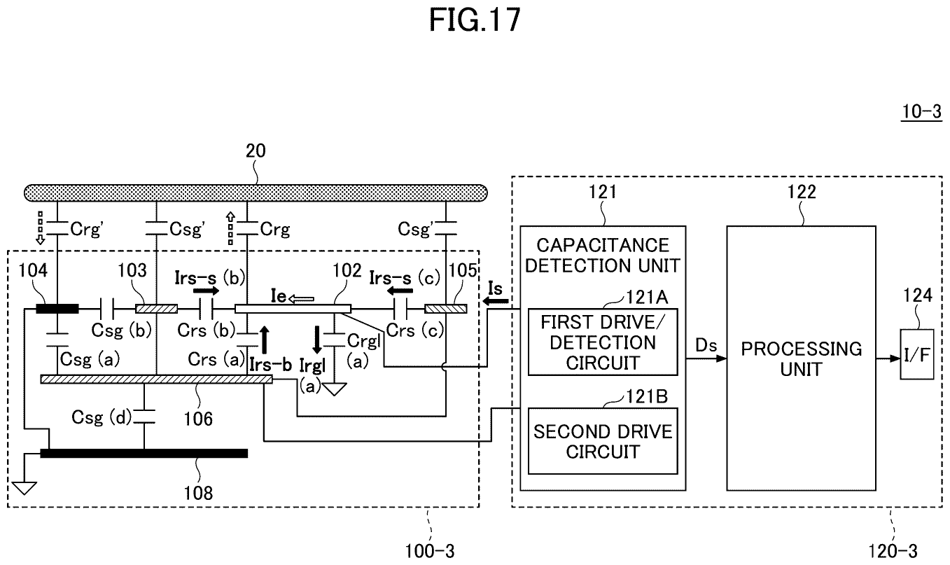

FIG. 16 is a diagram showing a circuit model of the capacitance detection device 10-3 according to the third embodiment (when no detection target 20 is present on the capacitance sensor 100-3). FIG. 17 is a diagram showing a circuit model of the capacitance detection device 10-3 according to the third embodiment (when the detection target 20 is present on the capacitance sensor 100-3).

As shown in FIGS. 16 and 17, the capacitance sensor 100-3 included in the capacitance detection device 10-3 according to the third embodiment is different from the capacitance sensor 100-2 included in the capacitance detection device 10-2 according to the second embodiment in that it further has a parasitic capacitance Csg(d) between the back shield electrode 106 and the back ground electrode 108 by further including the back ground electrode 108, the side ground electrode 104 is electrically connected to the back ground electrode 108, and the back ground electrode 108 is connected to the ground potential of the circuit board 11 as the detection circuit 120 is.

A detection circuit 120-3 included in the capacitance detection device 10-3 according to the third embodiment is the same as the detection circuit 120-2 included in the capacitance detection device 10-2 according to the second embodiment and the detection circuit 120 included in the capacitance detection device 10 according to the first embodiment.

### (Detection Operation of Capacitance Sensor 100-3)

The capacitance sensor 100-3 according to the third embodiment configured as described above can detect the capacitance (Crg+Crg′) of the detection target 20 by means of the detection electrode 102 as in the capacitance sensor 100-2 according to the second embodiment. The detection circuit 120-3 according to the third embodiment can determine the mounting state of the detection target 20 on the capacitance sensor 100-3 (the presence or absence of a detection target 20, the number of detection targets 20, and the like) based on the capacitance (Crg+Crg′) of the detection target 20 detected by the detection electrode 102.

The capacitance sensor 100-3 according to the third embodiment includes the first side shield electrode 103 and the second side shield electrodes 105 that are disposed parallel with the detection electrode 102 on the upper surface 101A of the substrate 101, and the first side shield electrode 103 and the second side shield electrodes 105 are driven by the second AC drive voltage V2 having the same frequency and the same phase as those of the first AC drive voltage V1 applied to the detection electrode 102. The capacitance sensor 100-3 according to the third embodiment includes the back shield electrode 106 provided on the lower surface 101B of the substrate 101 to face the detection electrode 102, and the back shield electrode 106 is driven by the second AC drive voltage V2 having the same frequency and the same phase as those of the first AC drive voltage V1 applied to the detection electrode 102.

Thus, in the capacitance sensor 100-3 according to the third embodiment, as shown in FIGS. 16 and 17, the sum of the current Irgl(b) flowing through the parasitic capacitance Crgl(b) between the detection electrode 102 and the side ground electrode 104 and the current Irgl(a) flowing through the parasitic capacitance Crgl(a) between the detection electrode 102 and the ground potential is offset by the sum of the current Irs-s(b) flowing through the parasitic capacitance Crs(b) between the first side shield electrode 103 and the detection electrode 102, the current Irs-s(c) flowing through the parasitic capacitance Crs(c) between the second side shield electrode 105 and the detection electrode 102, and the current Irs-b flowing through the parasitic capacitance Crs(a) between the back shield electrode 106 and the detection electrode 102.

This is because, in FIG. 16, the capacitance detection unit 121 (the first drive/detection circuit 121A) adjusts the amplitude of the first AC drive voltage V1 applied to the detection electrode 102 to be smaller than the amplitude of the second AC drive voltage such that the sum of the current Irs-b, the current Irs-s(b), and the current Irs-s(c) flowing into the detection electrode 102 from the back shield electrode 106, the first side shield electrode 103, and the second side shield electrode 105 to which the second AC drive voltage V2 is applied becomes equal to the sum of the current Irgl(a) and the current Irgl(b) flowing out of the detection electrode 102.

Therefore, the capacitance sensor 100-3 according to the third embodiment can reduce the sum of the parasitic capacitance Crgl(b) between the detection electrode 102 and the side ground electrode 104 and the parasitic capacitance Crgl(a) between the detection electrode 102 and the ground potential by the sum of the parasitic capacitance Crs(b) between the first side shield electrode 103 and the detection electrode 102, the parasitic capacitance Crs(c) between the second side shield electrode 105 and the detection electrode 102, and the parasitic capacitance Crs(a) between the back shield electrode 106 and the detection electrode 102.

Therefore, by means of the parasitic capacitance Crs(c) between the second side shield electrode 105 and the detection electrode 102, the capacitance sensor 100-3 according to the third embodiment can cause the currents (Irs-b, Irs-s(b), and Irs-s(c)) to flow through the parasitic capacitances Crs(a), Crs(b), and Crs(c) between the detection electrode 102 and the respective shields at more effectively divided terms of a ratio than those in the capacitance sensor 100 according to the first embodiment, and can efficiently reduce the imbalance between the terms of the ratio at which the parasitic capacitances Crgl(a) and Crgl(b) of the detection electrode 102 are reduced. In particular, the capacitance sensor 100-3 according to the third embodiment can increase the term of the ratio at which the parasitic capacitance Crgl(a) between the detection electrode 102 and the ground potential is reduced, and can efficiently and substantially achieve a high SN ratio of the detection signal.

In addition, since the second side shield electrode 105 is provided parallel with the detection electrode 102 on the outer side (in the X-axis direction), the capacitance sensor 100-3 according to the third embodiment can prevent an external noise, which is from the outer side in the width direction (the X-axis direction) of the capacitance sensor 100-3, from flowing into the detection electrode 102, by means of the second side shield electrode 105 to which the second AC drive voltage V2 is applied. Thus, the capacitance sensor 100-3 can improve the external noise resistance. Therefore, the capacitance sensor 100-3 according to the third embodiment can improve the stability of the high SN ratio of the detection signal better than the capacitance sensor 100 according to the first embodiment.

As described above, the capacitance sensor 100-3 according to the third embodiment can reduce the parasitic capacitances Crgl(Crgl(a)+Crgl(b)) generated between the detection electrode 102 and the ground potential and side ground electrode 104 by the parasitic capacitances (Crs(a)+Crs(b)+Crs(c)) of the first side shield electrode 103, the second side shield electrode 105, and the back shield electrode 106 when no detection target 20 is present on the capacitance sensor 100-3 as shown in FIG. 16. As shown in FIG. 17, when the detection target 20 is present on the capacitance sensor 100-3, the capacitance detected by the detection electrode 102 becomes a capacitance from which a considerable part of the parasitic capacitances Crgl(Crgl(a)+Crgl(b)) is eliminated, and substantially becomes the capacitance (Crg+Crg′) of the detection target 20. Therefore, the detection accuracy of the detection target 20 by the detection electrode 102 can be further improved. The capacitance (Crg+Crg′) of the detection target 20 detected by the detection electrode 102 is detected by the first drive/detection circuit 121A as the change Ie in the current Is.

In the capacitance sensor 100-3 according to the third embodiment, as shown in FIG. 17, when the detection target 20 is present, the capacitance Crg is generated between the detection electrode 102 and the detection target 20, and the capacitance Crg′ is generated between the detection target 20 and the side ground electrode 104. Therefore, in the capacitance sensor 100-3 according to the third embodiment, when the detection target 20 is present, the capacitance of the detection target 20 detected by the detection electrode 102 is amplified to the sum of the capacitance Crg and the capacitance Crg′. Therefore, the detection accuracy of the detection target 20 by the detection electrode 102 can be enhanced.

In addition, by including the back ground electrode 108 that has an area (or a volume) and a ground potential capacity greater than those of the side ground electrode 104 and is connected to the ground potential, the capacitance sensor 100-3 according to the third embodiment can effectively attenuate an external electromagnetic noise coming from the lower side (from the negative side on the Z-axis). In addition, by including the back ground electrode 108 electrically connected to the side ground electrode 104, the capacitance sensor 100-3 according to the third embodiment can improve the external noise resistance better than the capacitance sensor 100-2 according to the second embodiment. Therefore, the capacitance sensor 100-3 according to the third embodiment can improve the stability of the potential of the side ground electrode 104 and prevent a noise from flowing into the detection electrode 102 better than the capacitance sensor 100-2 according to the second embodiment. Thus, the stability of the high SN ratio of the detection signal can be improved.

### (Example of How Detection Target 20 is Detected by Capacitance Sensor 100-3)

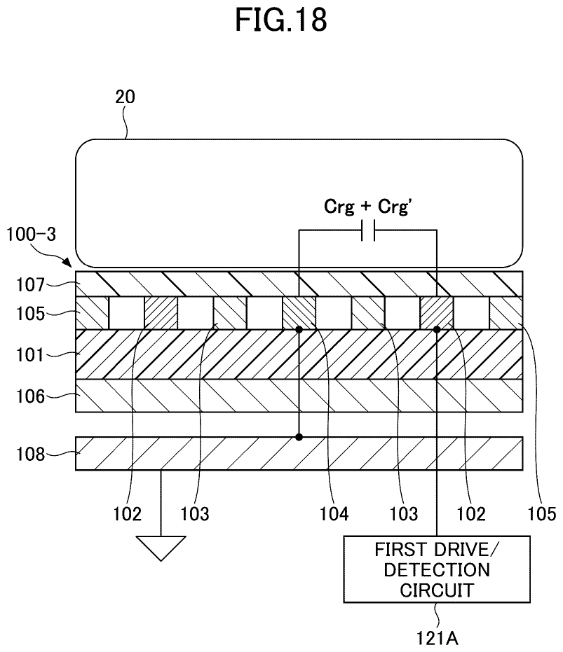

FIG. 18 is a diagram showing an example of how a detection target 20 is detected by the capacitance sensor 100-3 according to the third embodiment.

As shown in FIG. 18, the detection target 20 is mounted on the capacitance sensor 100-3 according to the third embodiment, straddling from the detection electrode 102 to which the first AC drive voltage V1 is applied by the first drive/detection circuit 121A to the side ground electrode 104 electrically connected to the ground potential together with the back ground electrode 108. Therefore, the substantial capacitance of the detection target 20 detected by the detection electrode 102 connected to the first drive/detection circuit 121A is the sum of the capacitance Crg between the detection electrode 102 and the detection target 20 and the capacitance Crg′ between the detection target 20 and the side ground electrode 104. Therefore, the capacitance sensor 100-3 according to the third embodiment can detect the detection target 20 with a high sensitivity by means of the detection electrode 102. Further, as shown in FIG. 18, since the capacitance sensor 100-3 according to the third embodiment includes the back ground electrode 108 connected to the side ground electrode 104, an external electromagnetic noise from the lower side (from the negative side on the Z-axis) can be effectively attenuated, and the external noise resistance can be improved. Therefore, because of being able to improve the stability of the ground potential of the side ground electrode 104 and prevent a noise from flowing into the detection electrode 102, the capacitance sensor 100-3 according to the third embodiment can improve the stability of the high SN ratio of the detection signal better than the capacitance sensor 100-2 according to the second embodiment.

In FIG. 18, only the capacitance value between the side ground electrode 104 disposed in the center in the width direction (X-axis direction) and the detection electrode 102 disposed on the right side (on the positive side on the X-axis) thereof is shown as the capacitance (Crg+Crg′) of the detection target 20.

As shown in FIG. 18, in the capacitance sensor 100-3 according to the third embodiment, the capacitance value in the case where the detection target 20 straddles from the side ground electrode 104 in the center in the width direction (the X-axis direction) to both the detection electrode 102 on the right side (the positive side on the X-axis) and the detection electrode 102 on the left side (the negative side on the X-axis) is approximately two times (Crg+Crg′) because the area over which the detection electrodes 102 face the detection target 20 is approximately two times as large as that over which one detection electrode 102 faces the detection target 20.

Further, as shown in FIG. 18, the capacitance sensor 100-3 according to the third embodiment includes the detection electrodes 102 on both the right and left sides (on the positive and negative sides on the X-axis) of the side ground electrode 104. Therefore, even when the user mounts the detection target 20 on the capacitance sensor 100-3 slid to either one side in the width direction (X-axis direction) (to the positive side or the negative side on the X-axis), the detection target 20 can be brought to straddlingly face the side ground electrode 104 and the detection electrode 102 on the one side provided in the sliding direction, and the capacitance (Crg+Crg′) of the detection target 20 can be detected. As a result, the capacitance sensor 100-3 according to the third embodiment can ensure reliability of detecting the presence or absence of the detection target 20.

As described above, the capacitance sensor 100-3 according to the third embodiment further includes the back ground electrode 108 provided on the other surface side of the substrate 101 to be spaced apart from and face the back shield electrode 106 and connected to the side ground electrode 104.

As a result, the capacitance sensor 100-3 according to the third embodiment can stabilize the potential of the side ground electrode 104 and prevent a noise from flowing into the detection electrode 102. Therefore, the stability of the high SN ratio of the output signal from the detection electrode 102 can be improved.

### Comparative Example

A conventional capacitance sensor 910 will be described below as a comparative example.

(Configuration of Conventional Capacitance sensor 910)

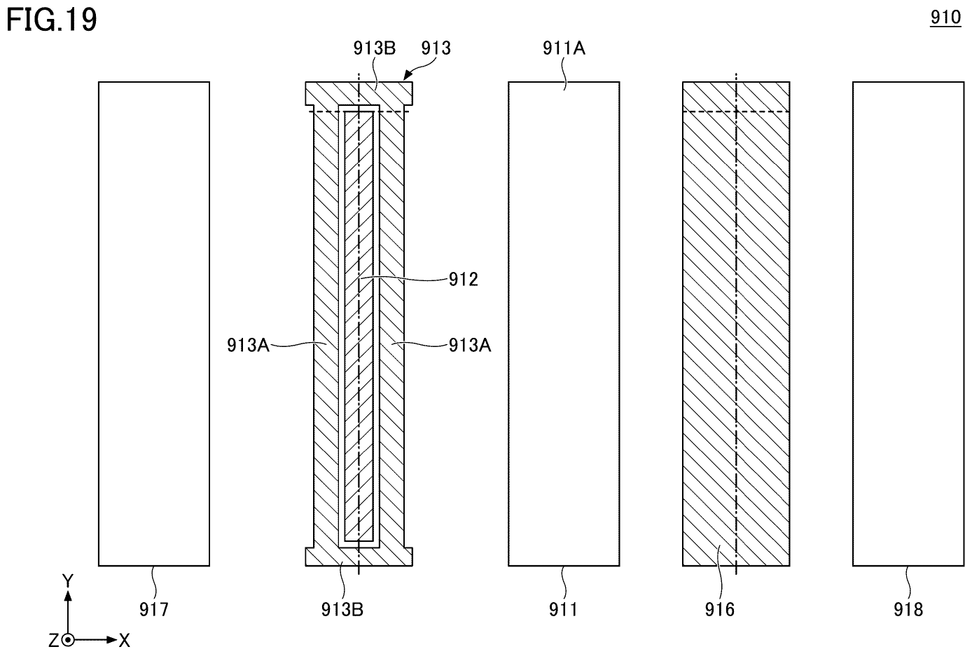

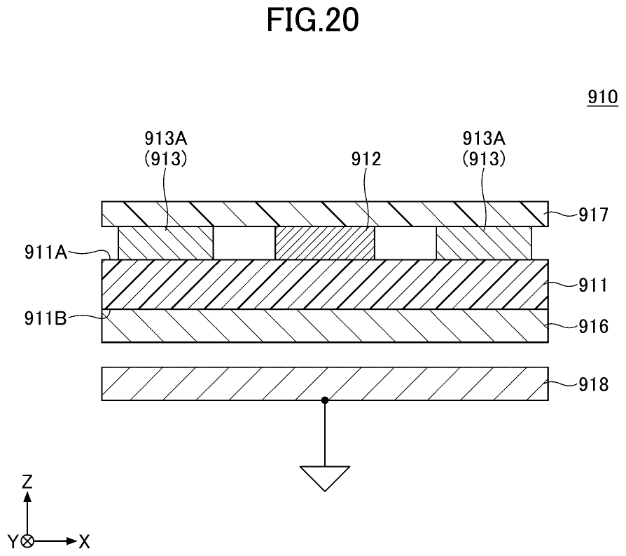

FIG. 19 is an exploded plan view of the conventional capacitance sensor 910. FIG. 20 is a cross-sectional view of the conventional capacitance sensor 910.

As shown in FIGS. 19 and 20, the conventional capacitance sensor 910 includes a substrate 911, a detection electrode 912, a side shield electrode 913, a back shield electrode 916, a cover 917, and a back ground electrode 918.

The substrate 911, the back shield electrode 916, the cover 917, and the back ground electrode 918 included in the conventional capacitance sensor 910 are the same as the substrate 101, the back shield electrode 106, the cover 107, and the back ground electrode 108 of the capacitance sensor 100-3 according to the third embodiment. The back ground electrode 918 is connected to the ground potential of the circuit board as the detection circuit 920 is.

The conventional capacitance sensor 910 is different from the capacitance sensor 100-3 according to the third embodiment in that it does not include the detection electrode 102, the first side shield electrode 103, the side ground electrode 104, and the second side shield electrodes 105, but instead includes the detection electrode 912 and the side shield electrode 913.

The detection electrode 912 is a thin film-like electrode composed of a conductive material, such as metal, inorganic conductive oxide, conductive resin, and the like, and provided on an upper surface 911A of the substrate 911. The detection electrode 912 has a strip shape extending linearly in the front-rear direction (Y-axis direction) on the upper surface 911A of the substrate 911. In the example shown in FIGS. 19 and 20, the detection electrode 912 is provided in the center of the capacitance sensor 910 in the width direction (the X-axis direction), i.e., provided between two linear parts 913A of the side shield electrode 913. Thus, the detection electrode 912 is provided parallel with the two linear parts 913A of the side shield electrode 913. The detection electrode 912 is electrically connected to a detection circuit 920. The detection electrode 912 is driven by the first AC drive voltage V1 being applied from the detection circuit 920.

The side shield electrode 913 is a thin film-like electrode composed of a conductive material, such as metal, inorganic conductive oxide, conductive resin, and the like and provided on the upper surface 911A of the substrate 911. The side shield electrode 913 includes the two linear parts 913A extending linearly in the front-rear direction (the Y-axis direction), and two connecting parts 913B extending linearly in the left-right direction (the X-axis direction) and connecting the ends of the two linear parts 913A with each other on the front side (on the positive side on the Y-axis) and the ends of the two linear parts 913A with each other on the rear side (on the negative side on the Y-axis), respectively. Thus, the side shield electrode 913 is formed in a rectangular frame shape in a plan view viewed from above (from the positive side on the Z-axis). The detection electrode 912 is disposed between the two linear parts 913A of the side shield electrode 913. That is, the two linear parts 913A of the side shield electrode 913 are disposed parallel with the detection electrode 912. The side shield electrode 913 is electrically connected to the detection circuit 920. The side shield electrode 913 is driven by the second AC drive voltage V2 being applied from the detection circuit 920.

### (Circuit Model of Conventional Electrostatic Detection System 900)

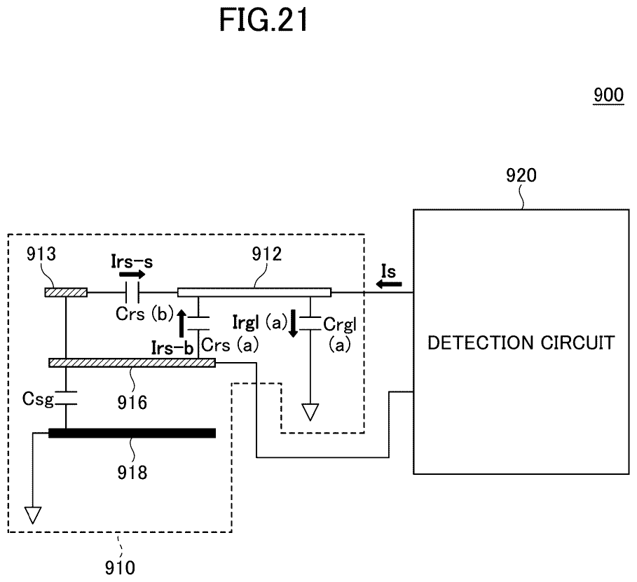

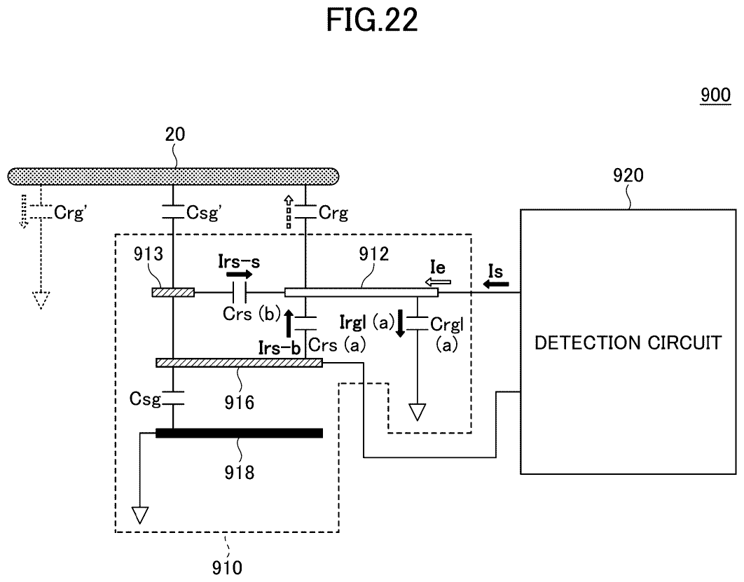

FIG. 21 is a diagram showing a circuit model of a conventional electrostatic detection system 900 (when no detection target 20 is present on the conventional capacitance sensor 910). FIG. 22 is a diagram showing a circuit model of the conventional electrostatic detection system 900 (when a detection target 20 is present on the conventional capacitance sensor 910).

As shown in FIGS. 21 and 22, the conventional electrostatic detection system 900 includes the capacitance sensor 910 and the detection circuit 920. The detection circuit 920 is the same as the detection circuit 120 according to the first embodiment, the detection circuit 120-2 according to the second embodiment, and the detection circuit 120-3 according to the third embodiment. Therefore, the detection circuit 920 includes a capacitance detection unit, a processing unit, and an I/F (none of which are shown). The detection electrode 912, the side shield electrode 913, and the back shield electrode 916 of the capacitance sensor 910 are electrically connected to the capacitance detection unit of the detection circuit 920. The side shield electrode 913 and the back shield electrode 916 are electrically connected to each other. Like the capacitance detection unit 121 shown in FIG. 16, the capacitance detection unit of the detection circuit 920 includes a first drive/detection circuit and a second drive circuit (both of which are not shown). The first drive/detection circuit of the detection circuit 920 generates the first AC drive voltage V1, and applies the first AC drive voltage V1 to the detection electrode 912. The first drive/detection circuit of the detection circuit 920 acquires the capacitance Crg of the detection target 20 detected by the detection electrode 912. The second drive circuit of the detection circuit 920 generates the second AC drive voltage V2 having the same frequency and the same phase as those of the first AC drive voltage V1, and applies the second AC drive voltage V2 to the side shield electrode 913 and the back shield electrode 916.

The detection circuit 920 has the circuit configuration shown in FIG. 7, like the detection circuit 120 according to the first embodiment, the detection circuit 120-2 according to the second embodiment, and the detection circuit 120-3 according to the third embodiment. The first drive/detection circuit 121A of the detection circuit 920 is connected to the detection electrode 912 through a lead wire that is the same as the lead wire 11A-1 shown in FIG. 7. The second drive circuit of the detection circuit 920 is electrically connected to the side shield electrode 913 and the back shield electrode 916 through a lead wire that is the same as the lead wire 11A-2 shown in FIG. 7.

### (Detection Operation of Conventional Capacitance Sensor 910)

In the conventional capacitance sensor 910 configured as described above, the detection electrode 912 is driven by the first AC drive voltage V1 supplied from the detection circuit 920. Thus, in the conventional capacitance sensor 910, when the mounting state of the detection target 20 on the conventional capacitance sensor 910 changes, the capacitance Crg of the detection target 20 detected by the detection electrode 912 changes. Therefore, the detection circuit 920 can determine the mounting state of the detection target 20 on the conventional capacitance sensor 910 (the presence or absence of the detection target 20, the number of detection targets 20, and the like) based on the capacitance Crg of the detection target 20 detected by the detection electrode 912.

The conventional capacitance sensor 910 includes the side shield electrode 913 disposed parallel with the detection electrode 912 on the upper surface 911A of the substrate 911, and the side shield electrode 913 is driven by the second AC drive voltage V2 having the same frequency and the same phase as those of the first AC drive voltage V1 applied to the detection electrode 912. The conventional capacitance sensor 910 includes the back shield electrode 916 disposed on a lower surface 911B of the substrate 911 to face the detection electrode 912, and the back shield electrode 916 is driven by the second AC drive voltage V2 having the same frequency and the same phase as those of the first AC drive voltage V1 applied to the detection electrode 912.

Thus, in the conventional capacitance sensor 910, as shown in FIGS. 21 and 22, the current Irgl(a) flowing through the parasitic capacitance Crgl(a) between the detection electrode 912 and the ground potential is offset by the sum of the current Irs-b flowing through the parasitic capacitance Crs(a) between the back shield electrode 916 and the detection electrode 912 and the current Irs-s flowing through the parasitic capacitance Crs(b) between the side shield electrode 913 and the detection electrode 912.

This is because, in FIG. 21, the capacitance detection unit 121 (the first drive/detection circuit 121A) of the detection circuit 920 adjusts the amplitude of the first AC drive voltage V1 applied to the detection electrode 912 to be smaller than the amplitude of the second AC drive voltage such that the sum of the current Irs-b and the current Irs-s flowing into the detection electrode 912 from the back shield electrode 916 and the side shield electrode 913 to which the second AC drive voltage V2 is applied becomes equal to the current Irgl(a) flowing out from the detection electrode 912.

Thus, in the conventional capacitance sensor 910, the parasitic capacitance Crgl(a) between the detection electrode 912 and the ground potential can be reduced by the sum of the parasitic capacitance Crs(a) between the back shield electrode 916 and the detection electrode 912 and the parasitic capacitance Crs(b) between the side shield electrode 913 and the detection electrode 912.

In this way, as shown in FIG. 21, the conventional capacitance sensor 910 can reduce the parasitic capacitance Crgl(a) generated between the detection electrode 912 and the ground potential by the parasitic capacitances (Crs(a)+Crs(b)) of the side shield electrode 913 and the back shield electrode 916 when no detection target 20 is present on the conventional capacitance sensor 910. As shown in FIG. 22, when the detection target 20 is present on the conventional capacitance sensor 910, the capacitance detected by the detection electrode 912 becomes a capacitance from which a significant part of the parasitic capacitance Crgl(a) is eliminated, and becomes the capacitance (Crg+Crg′) of the detection target 20 apparently. Therefore, the detection accuracy of the detection target 20 by the detection electrode 912 seems to be improved.

However, the conventional capacitance sensor 910 is different from the capacitance sensor 100-3 according to the third embodiment in that it does not include the side ground electrode 104. Therefore, in the conventional capacitance sensor 910, as shown in FIG. 22, when the detection target 20 is present, the capacitance Crg is generated between the detection electrode 912 and the detection target 20, and the capacitance Crg′ is also generated between the detection target 20 and the ground potential, but the capacitance Crg′ is extremely small because the detection target 20 is far from the ground potential. Therefore, in the conventional capacitance sensor 910, when the detection target 20 is present, the capacitance of the detection target 20 substantially detected by the detection electrode 912 is only the capacitance Crg, failing to improve the detection accuracy of the detection target 20 by the detection electrode 912.

### (Example of How Detection Target 20 is Detected by Conventional Capacitance Sensor 910)

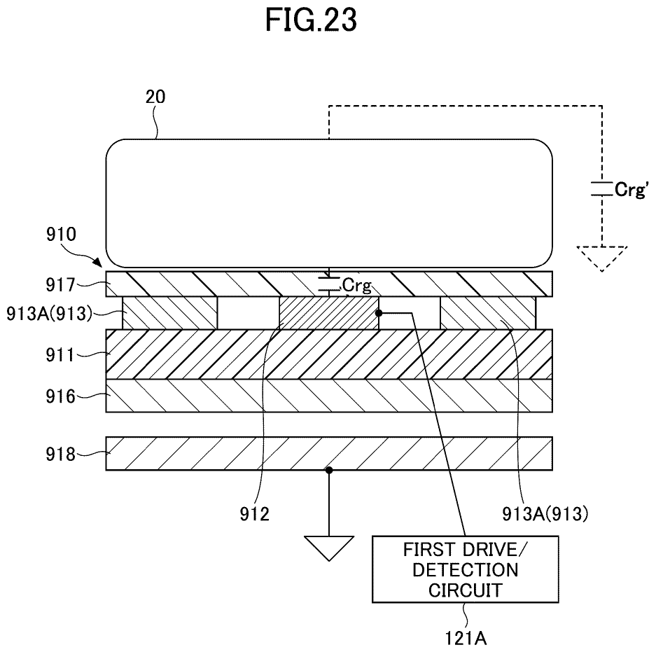

FIG. 23 is a diagram showing an example of how the detection target 20 is detected by the conventional capacitance sensor 910.

As shown in FIG. 23, in the conventional capacitance sensor 910, the detection target 20 is mounted on the detection electrode 912 to which the first AC drive voltage V1 is applied by the first drive/detection circuit 121A of the detection circuit 920. Therefore, the capacitance Crg is generated between the detection electrode 912 and the detection target 20. Further, as shown in FIG. 23, the capacitance Crg′ is generated between the detection target 20 and the ground potential. However, the capacitance Crg′ is extremely small because the distance between the detection target 20 and the ground potential is long. Therefore, the capacitance of the detection target 20 substantially detected by the detection electrode 912 is the capacitance Crg between the detection electrode 912 and the detection target 20. Therefore, the conventional capacitance sensor 910 cannot detect the detection target 20 with a high sensitivity by means of the detection electrode 912. Therefore, the conventional capacitance sensor 910 cannot detect the detection target 20 having a low conductivity or a low dielectric constant with a high sensitivity.

### EXPERIMENT EXAMPLES

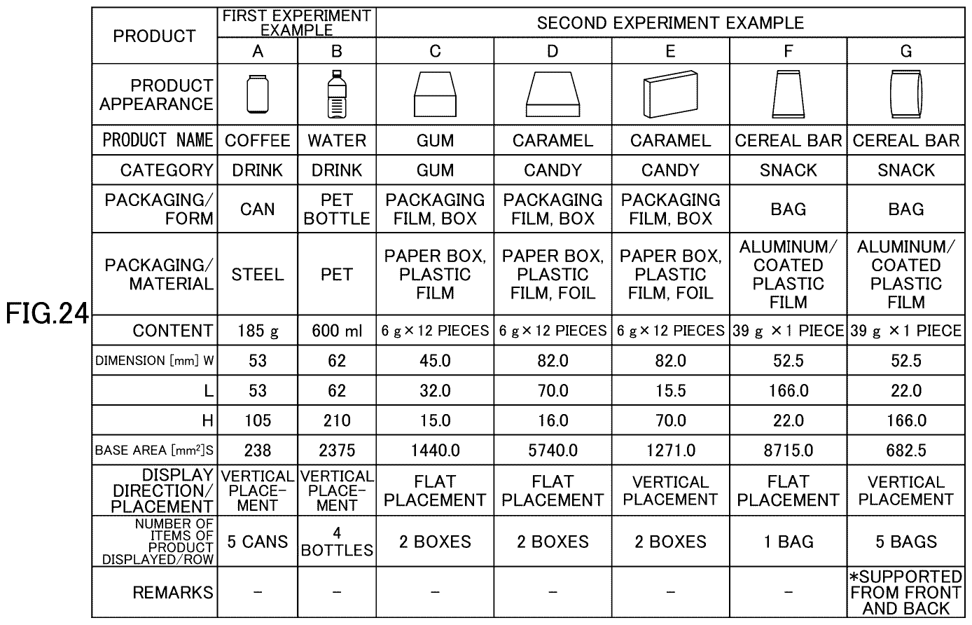

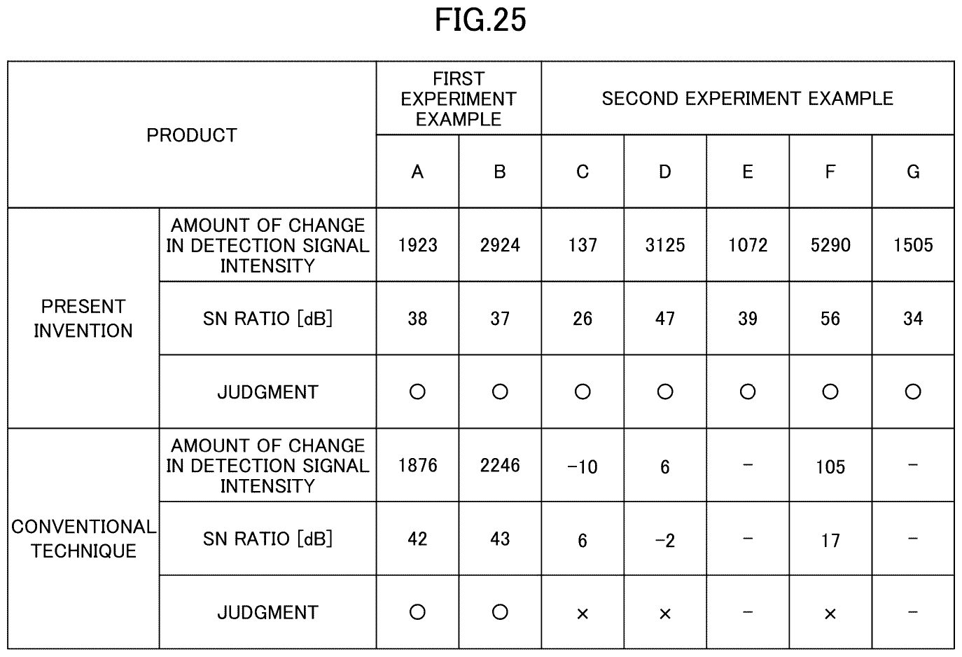

Hereinafter, experiment examples using the capacitance sensor 100-3 according to the third embodiment and the conventional capacitance sensor 910 will be described. In the capacitance sensor 100-3 according to the third embodiment, copper was used as the material for the side ground electrode 104, the detection electrode 102, the first side shield electrode 103, the second side shield electrodes 105, and the back shield electrode 106, an aluminum plate was used as the material for the back ground electrode 108, and PMMA resin (polymethyl methacrylate resin) was used as the material for the cover 107 and the substrate 101. In the conventional capacitance sensor 910, copper was used as the material for the detection electrode 912 and the side shield electrode 913, an aluminum plate was used as the material for the back shield electrode 916, and PMMA resin (polymethyl methacrylate resin) was used as the material for the cover 917 and the substrate 911. FIG. 24 is a table showing a list of products used in a first experiment example and a second experiment example. FIG. 25 is a table showing a list of detection results in the first experiment example and the second experiment example.

### First Experiment Example

In the first experiment example, for each of the product A and the product B shown in FIG. 24, a change in the capacitance (a change in the detection signal intensity) accompanying a change in the display state on the shelf board 21 of the product shelf was detected by the capacitance sensor 100-3 according to the third embodiment and the conventional capacitance sensor 910. Specifically, a change in the capacitance (a change in the detection signal intensity) when one item of the product was taken out from among the number of items of the product displayed in one row was detected.
Product A: a canned drink (coffee, vertical placement): the number of items of the product displayed in one row was changed from 5 to 4 by taking out one item.
Product B: a PET bottle drink (water, vertical placement): the number of items of the product displayed in one row was changed from 4 to 3 by taking out one item.

As shown in FIG. 25, in the first experiment example, a relatively high amount of change in the detection signal intensity and a relatively high SN ratio (20 db or greater) could be obtained for both of the product A and the product B by both of the capacitance sensor 100-3 according to the third embodiment and the conventional capacitance sensor 910.

As described above, in the first experiment example, both the capacitance sensor 100-3 according to the third embodiment and the conventional capacitance sensor 910 could detect a change in the display state of the products (the amount of change in the detection signal intensity) with a high sensitivity. It is considered that this is because the product A and the product B used in the first experiment example contain mainly water because they were drinks and had a relatively high conductivity or a high dielectric constant, so that a sufficient capacitance value could be obtained as the capacitance of the detection target 20 regardless of the presence or absence of the side ground electrode 104.

### Second Experiment Example

In the second experiment example, for each of the product C to the product G shown in FIG. 24, a change in the capacitance (a change in the detection signal intensity) accompanying a change in the display state on the shelf board 21 of the product shelf was detected by the capacitance sensor 100-3 according to the third embodiment and the conventional capacitance sensor 910. Specifically, a change in the capacitance (a change in the detection signal intensity) when one item was taken out from the number of items of the product displayed in one row was detected.
Product C: a boxed confectionery (gum, flat placement): the number of items of the product displayed in one row was changed from 2 to 1 by taking out one item.
Product D: a boxed confectionery (caramel, flat placement): the number of items of the product displayed in one row was changed from 2 to 1 by taking out one item.
Product E: a boxed confectionery (caramel, vertical placement): the number of items of the product displayed in one row was changed from 2 to 1 by taking out one item.
Product F: a bag sweet (serial bar, flat placement): the number of items of the product displayed in one row was changed from 1 to 0 by taking out one item.
Product G: a bag sweet (serial bar, vertical placement): the number of items of the product displayed in one row was changed from 5 to 4 by taking out one item.

As shown in FIG. 25, a sufficient amount of change in the detection signal intensity and a sufficient SN ratio (20 dB or greater) could be obtained for all of the products C to G by the capacitance sensor 100-3 according to the third embodiment.

On the other hand, as shown in FIG. 25, a sufficient amount of change in the detection signal intensity and a sufficient SN ratio could be obtained for none of the products C to G by the conventional capacitance sensor 910.

Thus, in the second experiment example, a change in the display state of the product (the amount of change in the detection signal intensity) could be detected with a high sensitivity by the capacitance sensor 100-3 according to the third embodiment, whereas a change in the display state of the products (amount of change in the detection signal intensity) could hardly be detected by the conventional capacitance sensor 910.

Since the products C to G used in the second experiment example contain little moisture and had a relatively low conductivity or a relatively low dielectric constant, it is considered that the conventional capacitance sensor 910, which does not include the side ground electrode 104, could not obtain a sufficient capacitance value as the capacitance of the detection target 20, although the capacitance sensor 100-3 according to the third embodiment including the side ground electrode 104 could obtain a sufficient capacitance value as the capacitance of the detection target 20.

### Third Experiment Example

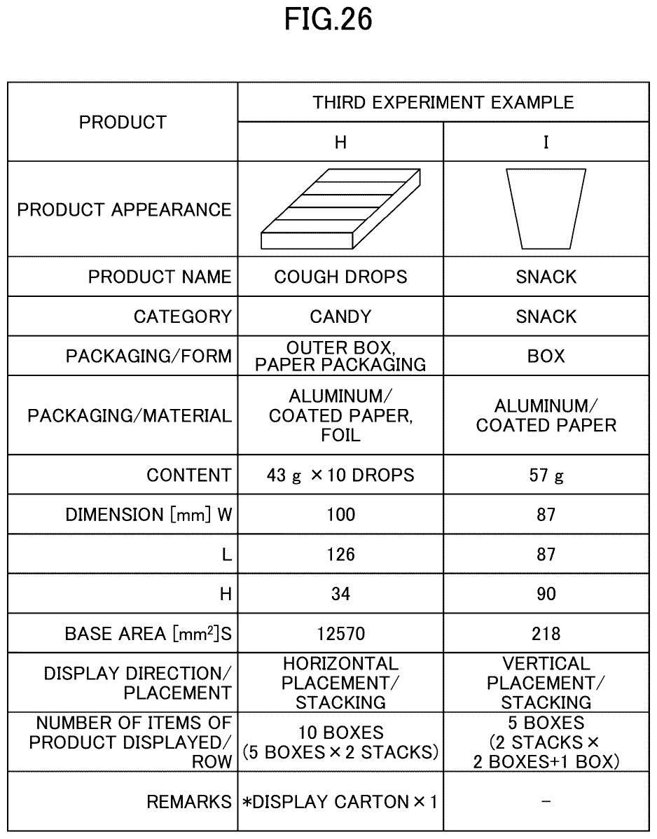

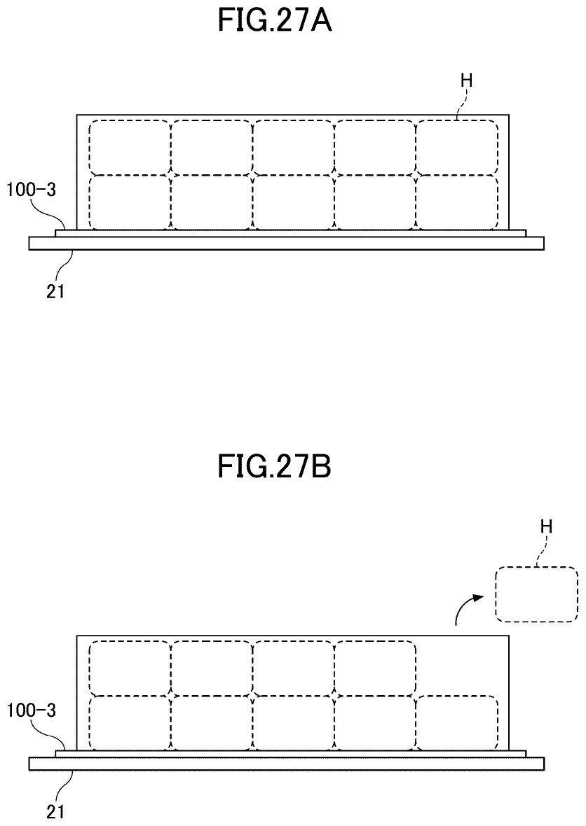

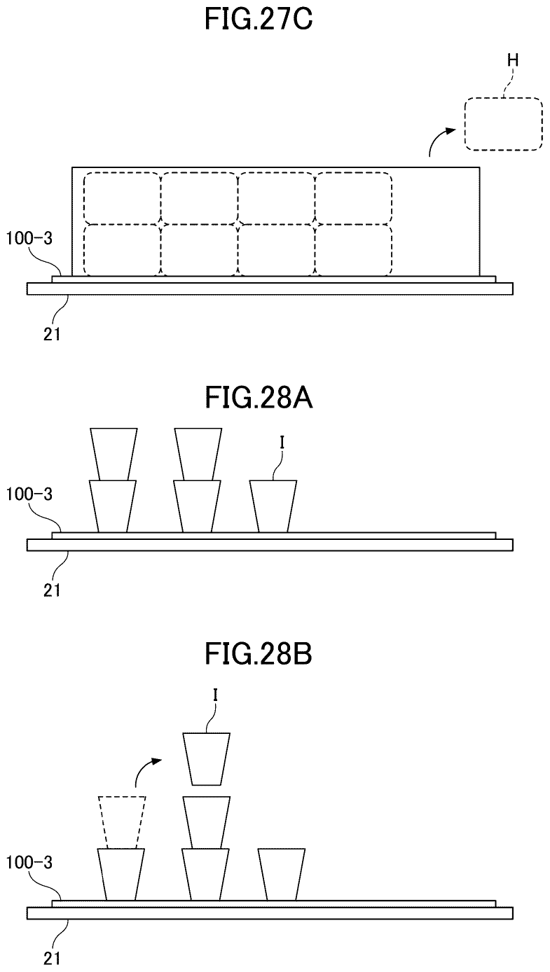

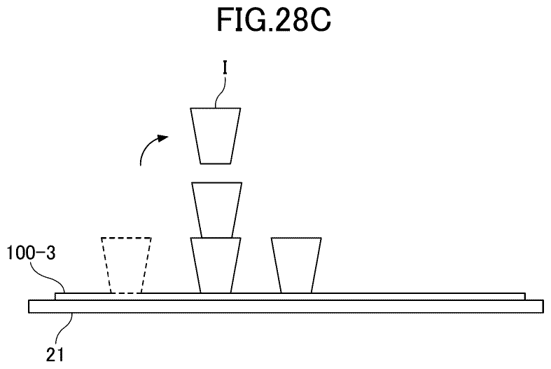

FIG. 26 is a table showing a list of products used in a third experiment example. FIG. 27 are diagrams showing a first example of the experimental procedure of the third experiment example. FIG. 28 are diagrams showing a second example of the experimental procedure of the third experiment example. FIG. 29 is a table showing a list of detection results in the third experiment example.

In the third experiment example, for each of the product H and the product I shown in FIG. 26, a change in the capacitance (a change in the detection signal intensity) accompanying a change in the display state on the shelf board 21 of the product shelf was detected by the capacitance sensor 100-3 according to the third embodiment.
Product H: a paper-packaged sweet in an outer box (candy, flat placement, 2 stacks)
Product I: a boxed confectionery (snack, vertical placement, 2 stacks)

For the product H, the experiment was conducted according to the experimental procedure shown in FIGS. 27A, 27B, and 27C. Specifically, as shown in FIG. 27A, 10 items of the product H displayed in 2 stacks×5 rows in an outer box were mounted on the capacitance sensor 100-3 installed on the shelf board 21. Next, as shown in FIG. 27B, one item of the product H on the second stack was taken out from the outer box, and a change in capacitance was detected by the capacitance sensor 100-3. Next, as shown in FIG. 27C, another one item of the product H on the first stack was taken out from the outer box, and a change in the capacitance was detected by the capacitance sensor 100-3.

For the product I, the experiment was conducted according to the experimental procedure shown in FIGS. 28A, 28B, and 28C. Specifically, as shown in FIG. 28A, 5 items of the product I displayed in 2 stacks×3 rows were mounted on the capacitance sensor 100-3 installed on the shelf board 21. Next, as shown in FIG. 28B, one item of the product I on the second stack was taken out, and a change in the capacitance was detected by the capacitance sensor 100-3. Next, as shown in FIG. 28C, another one item of the product I on the first stack was taken out, and a change in the capacitance was detected by the capacitance sensor 100-3.

As shown in FIG. 29, in the third experiment example, the capacitance sensor 100-3 according to the third embodiment was able to obtain a sufficient amount of change in the detection signal intensity and a sufficient SN ratio (20 dB or greater) both when an item of the product on the second stack was taken out and when an item of the product on the first stack was taken out for both of the product H and the product I.

In particular, although the product H and the product I used in the third experiment example contain little moisture and had a relatively low conductivity or a relatively low dielectric constant, the capacitance sensor 100-3 according to the third embodiment was able to obtain a sufficient amount of change in the detection signal intensity and a sufficient SN ratio (20 dB or greater) even when an item of the product H and an item of the product I on the second stack, which were far from the capacitance sensor 100-3, were taken out. It is considered that this is because the capacitance sensor 100-3 according to the third embodiment includes the side ground electrode 104, which made it possible to obtain a sufficient capacitance value as the capacitance of the detection target 20.

### MODIFIED EXAMPLES

### First Modified Example

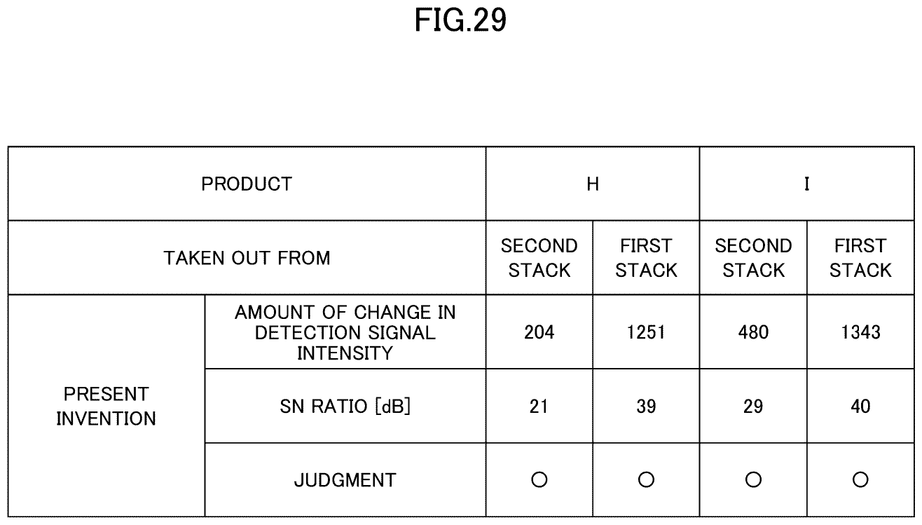

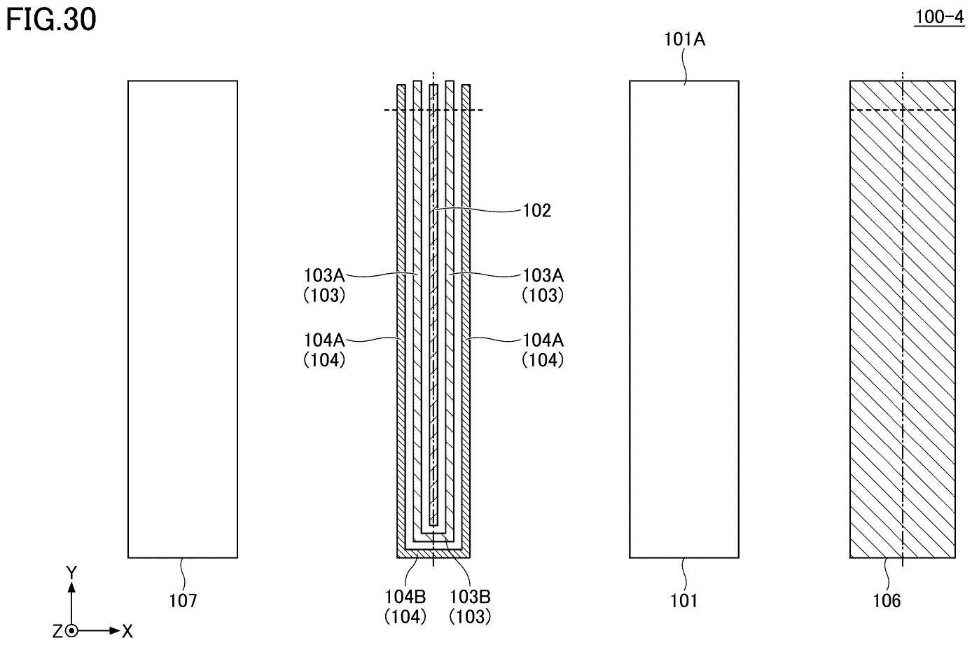

FIG. 30 is an exploded plan view of a capacitance sensor 100-4 according to a first modified example. FIG. 31 is a cross-sectional view of the capacitance sensor 100-4 according to the first modified example.

As shown in FIGS. 30 and 31, the capacitance sensor 100-4 according to the first modified example includes a detection electrode 102 extending linearly in the center in the left-right direction (the X-axis direction). The capacitance sensor 100-4 includes two linear parts 103A of a first side shield electrode 103 that extend linearly on both outer sides of the detection electrode 102 in the left-right direction (the X-axis direction). The first side shield electrode 103 includes one connecting part 103B that connects the ends of the two linear parts 103A with each other on the rear side (the on the negative side on the Y-axis). Thus, the first side shield electrode 103 is formed in a letter-U shape surrounding the detection electrode 102 in a plan view viewed from above (from the positive side on the Z-axis).

The capacitance sensor 100-4 includes two linear parts 104A of a side ground electrode 104 that extend linearly on both outer sides of the two linear parts 103A of the first side shield electrode 103 in the left-right direction (the X-axis direction). The side ground electrode 104 includes one connecting part 104B that connects the ends of the two linear parts 104A with each other on the rear side (on the negative side on the Y-axis). Thus, the side ground electrode 104 is formed in a letter-U shape surrounding the detection electrode 102 and the first side shield electrode 103 in a plan view viewed from above (from the positive side on the Z-axis). The side ground electrode 104 is electrically connected to the ground potential of the circuit board 11 as the detection circuit 120 is.

That is, the detection electrode 102 is disposed parallel with the two linear parts 103A of the first side shield electrode 103 and the two linear parts 104A of the side ground electrode 104. The capacitance sensor 100-4 according to the first modified example has a configuration in which the detection electrode 102 and the side ground electrode 104 of the capacitance sensor 100 according to the first embodiment are interchanged locationally.

The capacitance sensor 100-4 includes a substrate 101, a back shield electrode 106, and a cover 107 like the capacitance sensor 100 according to the first embodiment.

The detection circuit 120 connected to the capacitance sensor 100-4 according to the first modified example is the same as the detection circuit 120 according to the first embodiment, and the capacitance detection unit 121 thereof has a circuit configuration shown in FIG. 7. Therefore, in the capacitance sensor 100-4 according to the first modified example, the detection electrode 102 is driven by the first AC drive voltage V1 being applied from the detection circuit 120.

In the capacitance sensor 100-4 according to the first modified example, the first side shield electrode 103 is electrically connected to the back shield electrode 106. Thus, in the capacitance sensor 100-4 according to the first modified example, the second AC drive voltage V2 having the same frequency and the same phase is applied to both the back shield electrode 106 and the first side shield electrode 103 from the detection circuit 120.

The circuit model of the capacitance sensor 100-4 according to the first modified example is the same as that described in the first embodiment (see FIGS. 5 and 6). Therefore, the capacitance sensor 100-4 according to the first modified example can reduce the sum of the parasitic capacitance Crgl(b) between the detection electrode 102 and the side ground electrode 104 and the parasitic capacitance Crgl(a) between the detection electrode 102 and the ground potential by the sum of the parasitic capacitance Crs(b) between the first side shield electrode 103 and the detection electrode 102 and the parasitic capacitance Crs(a) between the back shield electrode 106 and the detection electrode 102.

### (Example of How Detection Target 20 is Detected by Capacitance Sensor 100-4)

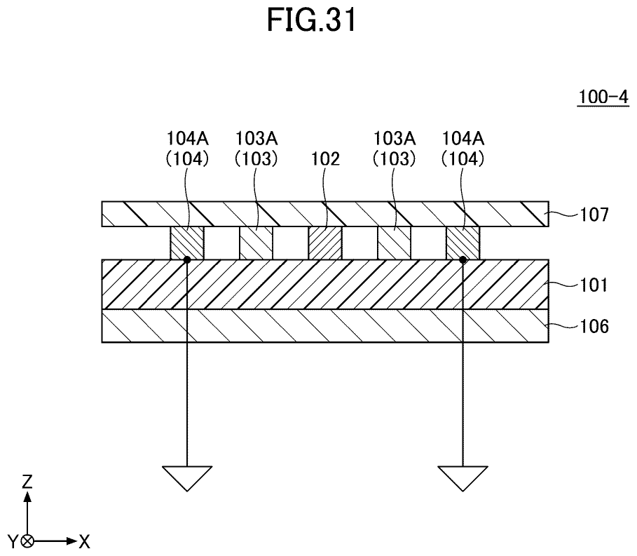

FIG. 32 is a diagram showing an example of how a detection target 20 is detected by the capacitance sensor 100-4 according to the first modified example.

As shown in FIG. 32, the detection target 20 is mounted on the capacitance sensor 100-4 according to the first modified example, straddling from the detection electrode 102 to which the first AC drive voltage V1 is applied by the first drive/detection circuit 121A to the side ground electrode 104 connected to the ground potential of the circuit board 11. Therefore, the capacitance of the detection target 20 substantially detected by the detection electrode 102 connected to the first drive/detection circuit 121A is the sum of the capacitance Crg between the detection electrode 102 and the detection target 20 and the capacitance Crg′ between the detection target 20 and the side ground electrode 104. Therefore, the capacitance sensor 100-4 according to the first modified example can detect the detection target 20 with a high sensitivity by means of the detection electrode 102.

Further, the capacitance sensor 100-4 according to the first modified example includes the side ground electrode 104 on both the right side and the left side (on the positive side and the negative side in the X-axis direction) of the detection electrode 102. Therefore, even when the user mounts the detection target 20 on the capacitance sensor 100-2 slid to either one side in the width direction (the X-axis direction) (to the positive side or the negative side on the X-axis), the detection target 20 can be brought to straddlingly face the detection electrode 102 and the side ground electrode 104 on the one side provided in the sliding direction, and the capacitance (Crg+Crg′) of the detection target 20 can be detected. Thus, the capacitance sensor 100-4 according to the first modified example can detect the presence or absence of the detection target 20 as the same capacitance value (Crg+Crg′) regardless of to which side in the width direction (the X-axis direction) the user slides the detection target 20 when mounting it.

Further, the capacitance sensor 100-4 according to the first modified example includes the side ground electrode 104 (104A) parallel with the detection electrode 102 on both outer sides (on the positive side and the negative side on the X-axis). Thus, the side ground electrode 104 (104A) connected to the ground potential can prevent an external noise from flowing into the detection electrode 102 from both the outer sides in the width direction of the capacitance sensor 100-4 according to the first modified example (from the positive side and the negative side on the X-axis). Thus, the capacitance sensor 100-4 according to the first modified example can improve the external noise resistance. Therefore, the capacitance sensor 100-7 according to the first modified example can improve the stability of the SN ratio of the detection signal.

### Second Modified Example

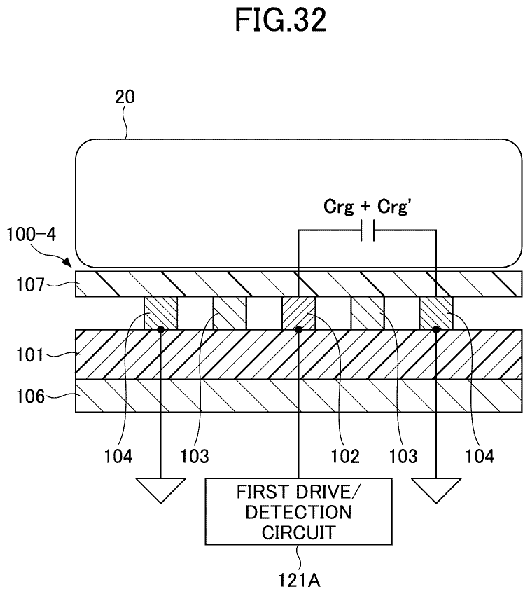

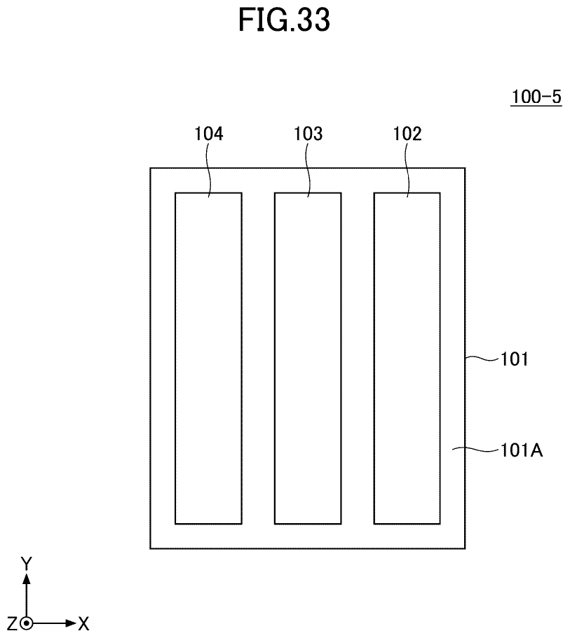

FIG. 33 is a plan view of a capacitance sensor 100-5 according to a second modified example. FIG. 34 is a cross-sectional view of the capacitance sensor 100-5 according to the second modified example.

The capacitance sensor 100-5 according to the second modified example is a modified example of the capacitance sensor 100 according to the first embodiment. In the capacitance sensor 100 according to the first embodiment, as a preferred example, the detection electrode 102 includes the connecting part 102B between the two linear parts 102A and the first side shield electrode includes the connecting part 103B between the two linear parts 103A. In this way, the detection electrode 102 and the first side shield electrode 103 are both formed in a letter-U shape in a plan view.

On the other hand, the capacitance sensor 100-5 according to the second modified example has a basic unit structure in which single undivided bodies of the side ground electrode 104, the first side shield electrode 103, and the detection electrode 102, each of which is linear in a plan view, are disposed parallel with each other on the upper surface 101A of the substrate 101, as shown in FIGS. 33 and 34.

Therefore, the capacitance sensor 100-5 according to the second modified example is the same as the capacitance sensor 100 according to the first embodiment except that the detection electrode 102 and the first side shield electrode 103 are not letter-U-shaped in a plan view. The capacitance sensor 100-5 according to the second modified example is connected to a detection circuit 120 that is the same as the detection circuit 120 according to the first embodiment. Therefore, the capacitance sensor 100-5 according to the second modified example can exhibit the same function as that of the capacitance sensor 100 according to the first embodiment except that the detection electrode 102 and the first side shield electrode 103 are not letter-U-shaped in a plan view.

As described above, the capacitance sensor 100-5 according to the second modified example includes the substrate 101, the detection electrode 102 disposed on one surface of the substrate 101, the first side shield electrode 103 disposed parallel with the detection electrode on the one surface of the substrate 101, and a back shield electrode 106 disposed on the other surface of the substrate 101 to face the detection electrode 102 through the substrate 101. A first AC drive voltage V1 is applied to the detection electrode 102, and a second AC drive voltage V2 having the same frequency and the same phase as those of the first AC drive voltage V1 is applied to the first side shield electrode 103 and the back shield electrode 106. The capacitance sensor 100-5 further includes the side ground electrode 104 that is disposed parallel with the detection electrode 102 and the first side shield electrode 103 on the one surface of the substrate 101, and is connected to the ground potential.

As a result, the capacitance sensor 100-5 according to the second modified example can detect the detection target 20 having a low conductivity or a low dielectric constant with a high sensitivity, like the capacitance sensor 100 according to the first embodiment.

In the capacitance sensor 100-5 according to the second modified example, the first side shield electrode 103 is disposed between the detection electrode 102 and the side ground electrode 104.

Thus, the capacitance sensor 100-5 according to the second modified example can increase the sensitivity of the detection circuit 120 by bringing about a state in which the parasitic capacitances mentioned above are reduced, and can detect even a minute change in the capacitance between the detection electrode 102 and the side ground electrode 104. Thus, the capacitance sensor 100-5 according to the second modified example can detect even a detection target 20 having a low dielectric constant in response to any change in the capacitance between the detection electrode 102 and the side ground electrode 104.

### Third Modified Example

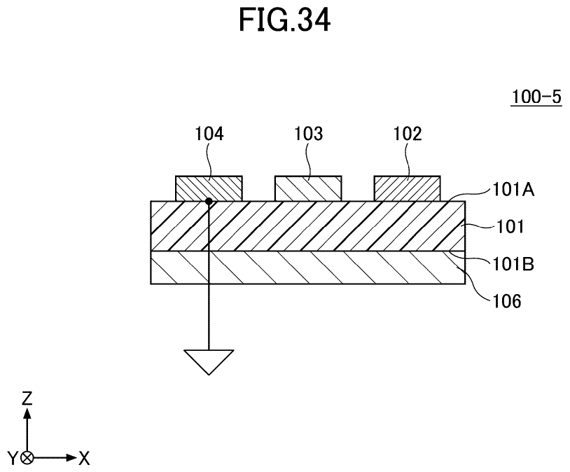

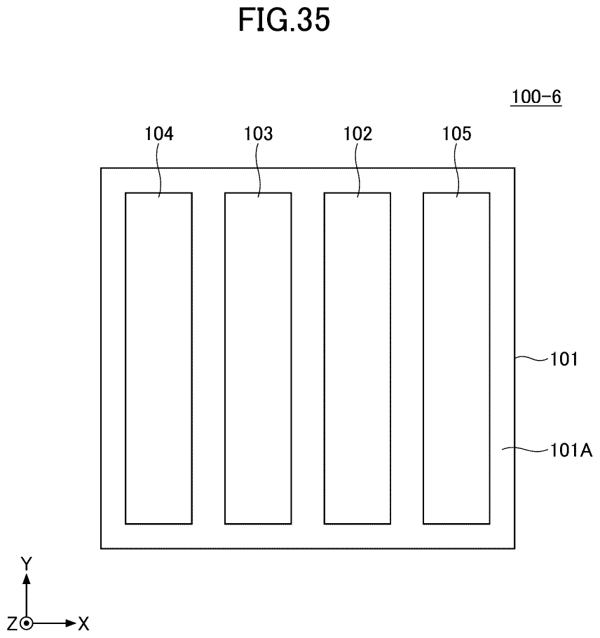

FIG. 35 is a plan view of a capacitance sensor 100-6 according to a third modified example. FIG. 36 is a cross-sectional view of the capacitance sensor 100-6 according to the third modified example.

The capacitance sensor 100-6 according to the third modified example is a modified example of the capacitance sensor 100-2 according to the second embodiment. In the capacitance sensor 100-2 according to the second embodiment, as a preferable example, the detection electrode 102 includes the connecting part 102B between the two linear parts 102A, and the first side shield electrode includes the connecting part 103B between the two linear parts 103A. In this way, the detection electrode 102 and the first side shield electrode 103 are both formed in a letter-U shape in a plan view.

On the other hand, as shown in FIGS. 35 and 36, the capacitance sensor 100-6 according to the third modified example has a basic unit structure in which single undivided bodies of the side ground electrode 104, the first side shield electrode 103, the detection electrode 102, and the second side shield electrode 105, each of which are linear in a plan view, are disposed parallel with each other on the upper surface 101A of the substrate 101.

Therefore, the capacitance sensor 100-6 according to the third modified example is the same as the capacitance sensor 100-2 according to the second embodiment except that the detection electrode 102 and the first side shield electrode 103 are not letter-U-shaped in a plan view. The capacitance sensor 100-6 according to the third modified example is connected to a detection circuit 120 that is the same as the detection circuit 120 according to the first embodiment and the detection circuit 120-2 according to the second embodiment. Therefore, the capacitance sensor 100-6 according to the third modified example can exhibit the same function as that of the second embodiment except that the detection electrode 102 and the first side shield electrode 103 are not letter-U-shaped in a plan view.

As described above, the capacitance sensor 100-6 according to the third modified example has a configuration in which, compared with the capacitance sensor 100-5 according to the second modified example, it further includes the second side shield electrode 105 disposed parallel with the detection electrode 102 on the one surface of the substrate 101. The detection electrode 102 is disposed between the first side shield electrode 103 and the second side shield electrode 105, and the second AC drive voltage V2 is applied to the second side shield electrode 105.

Thus, the capacitance sensor 100-6 according to the third modified example can prevent a noise from flowing into the detection electrode 102 from a side on which the second side shield electrode 105 is present, and can secure a high detection sensitivity at a high SN ratio.

Further, the capacitance sensor 100-6 according to the third modified example can cause the currents (Irs-b, Irs-s(b), and Irs-s(c)) to flow through the parasitic capacitances Crs(a), Crs(b), and Crs(c) between the detection electrode 102 and the respective shields at more effectively divided terms of a ratio, and can efficiently reduce the imbalance between the terms of the ratio at which the parasitic capacitances Crgl(a) and Crgl(b) of the detection electrode 102 is reduced. In particular, the capacitance sensor 100-6 according to the third modified example can increase the term of the ratio at which the parasitic capacitance Crgl(a) between the detection electrode 102 and the ground potential is reduced, and can efficiently and substantially achieve a high SN ratio of the detection signal.

Further, in the capacitance sensor 100-6 according to the third modified example, since the side ground electrode 104 is disposed parallel with the detection electrode 102 on the left side (the negative side on the X-axis), an external noise from the left side (the negative side on the X-axis) in the width direction of the capacitance sensor 100-6 according to the third modified example can be prevented from flowing into the detection electrode 102 by means of the side ground electrode 104 connected to the ground potential. Further, in the capacitance sensor 100-6 according to the third modified example, since the second side shield electrode 105 is disposed parallel with the detection electrode 102 on the right side (the positive side on the X-axis), an external noise from the right side (the positive side on the X-axis) in the width direction of the capacitance sensor 100-6 according to the third modified example can be prevented from flowing into the detection electrode 102 by means of the second side shield electrode 105 to which the second AC drive voltage V2 is applied. Thus, the capacitance sensor 100-6 according to the third modified example can improve the external noise resistance. Accordingly, the capacitance sensor 100-6 according to the third modified example can improve the stability of the SN ratio of the detection signal.

### Fourth Modified Example

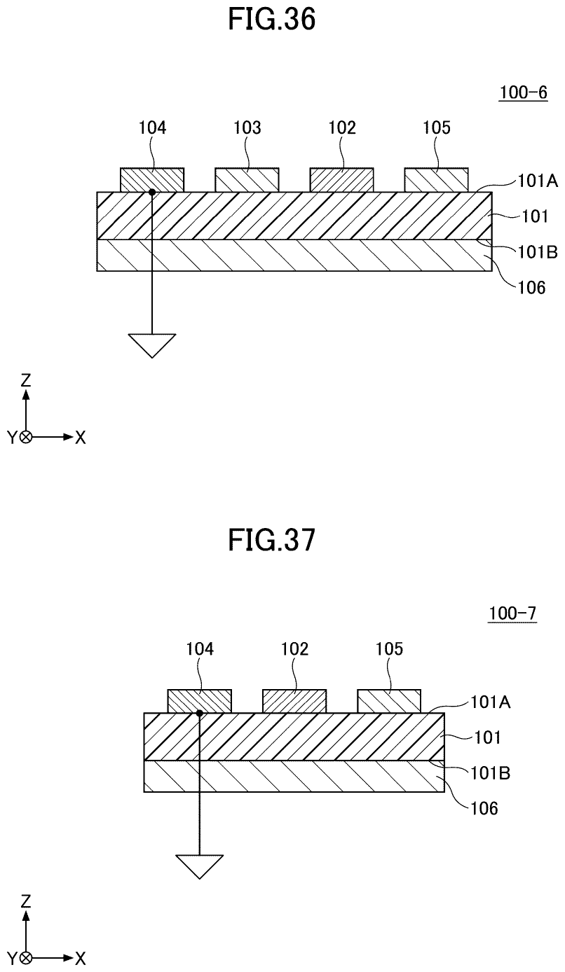

FIG. 37 is a cross-sectional view of a capacitance sensor 100-7 according to a fourth modified example.

In the capacitance sensor 100-7 according to the fourth modified example, as shown in FIG. 37, the side ground electrode 104, the detection electrode 102, and the second side shield electrode 105, which are all linear in a plan view, are disposed parallel with each other on the upper surface 101A of the substrate 101, and the back shield electrode 106 is disposed on the lower surface 101B of the substrate 101 to face the detection electrode 102.

The capacitance sensor 100-7 according to the fourth modified example is connected to the detection circuit 120-2 that is the same as the detection circuit 120-2 according to the second embodiment. The detection electrode 102 of the capacitance sensor 100-7 according to the fourth modified example is driven by the first AC drive voltage V1 being applied from the detection circuit 120-2.

In the capacitance sensor 100-7 according to the fourth modified example, the second side shield electrode 105 and the back shield electrode 106 are driven by the second AC drive voltage V2 being applied from the detection circuit 120-2. The second AC drive voltage V2 has the same frequency and the same phase as those of the first AC drive voltage V1 applied to the detection electrode 102. The second side shield electrode 105 and the back shield electrode 106 are electrically connected to each other. The side ground electrode 104 is connected to the ground potential of the circuit board 11 as the detection circuit 120-2 is.

The capacitance sensor 100-7 according to the fourth modified example can reduce the sum (Crgl(a)+Crgl(b)) of the parasitic capacitance between the detection electrode 102 and the ground potential and the parasitic capacitance between the detection electrode 102 and the side ground electrode 104 by the sum (Crs(a)+Crs(c)) of the parasitic capacitance between the detection electrode 102 and the back shield electrode 106 and the parasitic capacitance between the detection electrode 102 and the second side shield electrode 105.

The capacitance sensor 100-7 according to the fourth modified example can detect the capacitance (Crg+Crg′) of the detection target 20 that is mounted to straddle from the detection electrode 102 to the side ground electrode 104.

Since the side ground electrode 104 is disposed parallel with the detection electrode 102 on the left side (the negative side on the X-axis), the capacitance sensor 100-7 according to the fourth modified example can prevent an external noise, which is from the left side in the width direction of the capacitance sensor 100-7 according to the fourth modified example (from the negative side on the X-axis), from flowing into the detection electrode 102 by means of the side ground electrode 104 connected to the ground potential. In addition, since the second side shield electrode 105 is disposed parallel with the detection electrode 102 on the right side (the positive side on the X-axis), the capacitance sensor 100-7 according to the fourth modified example can prevent an external noise, which is from the right side in the width direction of the capacitance sensor 100-7 according to the fourth modified example (from the positive side on the X-axis), from flowing into the detection electrode 102 by means of the second side shield electrode 105 to which the second AC drive voltage V2 is applied. Thus, the capacitance sensor 100-7 according to the fourth modified example can improve the external noise resistance. Therefore, the capacitance sensor 100-7 according to the fourth modified example can improve the stability of the SN ratio of the detection signal.

### Fifth Modified Example

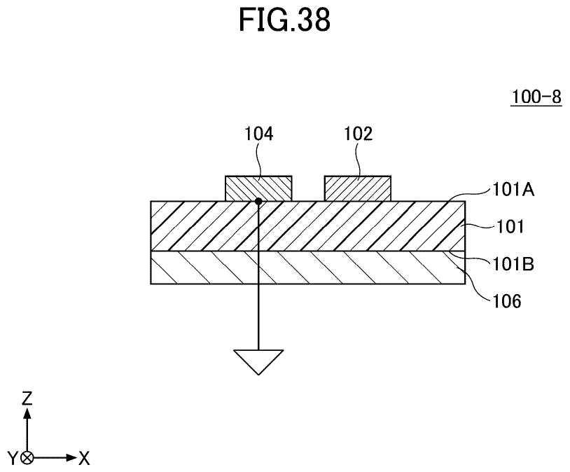

FIG. 38 is a cross-sectional view of a capacitance sensor 100-8 according to a fifth modified example.

In the capacitance sensor 100-8 according to the fifth modified example, as shown in FIG. 38, the side ground electrode 104 and the detection electrode 102, both of which are linear in a plan view, are disposed parallel with each other on the upper surface 101A of the substrate 101, and the back shield electrode 106 is disposed on the lower surface 101B of the substrate 101 to face the detection electrode 102.

The capacitance sensor 100-8 according to the fifth modified example is connected to the detection circuit 120 that is the same as the detection circuit 120 according to the first embodiment. The detection electrode 102 of the capacitance sensor 100-8 according to the fifth modified example is driven by the first AC drive voltage V1 being applied from the detection circuit 120.

In the capacitance sensor 100-8 according to the fifth modified example, the back shield electrode 106 is driven by the second AC drive voltage V2 being applied from the detection circuit 120. The second AC drive voltage V2 has the same frequency and the same phase as those of the first AC drive voltage V1 applied to the detection electrode 102. The side ground electrode 104 is connected to the ground potential of the circuit board 11 as the detection circuit 120 is.

Thus, the capacitance sensor 100-8 according to the fifth modified example can reduce the sum (Crgl(a)+Crgl(b)) of the parasitic capacitance between the detection electrode 102 and the ground potential and the parasitic capacitance between the detection electrode 102 and the side ground electrode 104 by the parasitic capacitance (Crs(a)) between the detection electrode 102 and the back shield electrode 106. Therefore, the capacitance sensor 100-8 according to the fifth modified example can detect the capacitance (Crg+Crg′) of the detection target 20 mounted to straddle from the detection electrode 102 to the side ground electrode 104.

### Sixth Modified Example

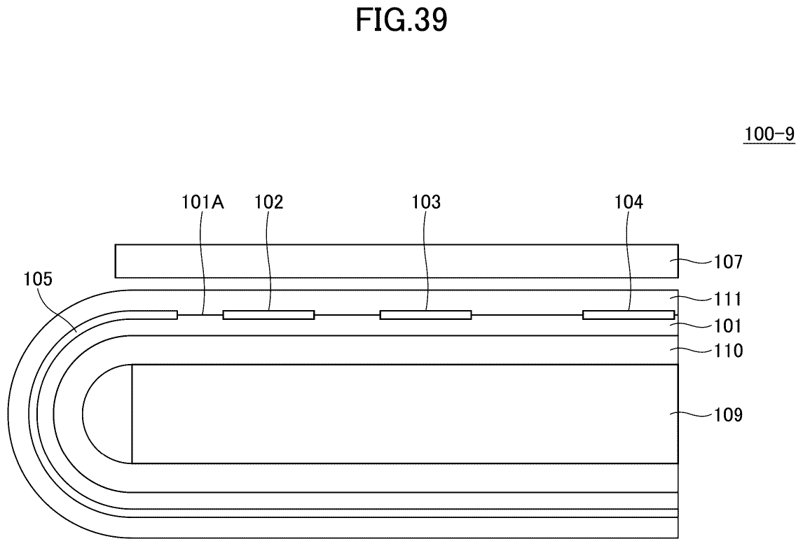

FIG. 39 is a cross-sectional view of a capacitance sensor 100-9 according to a sixth modified example. As shown in FIG. 39, in the capacitance sensor 100-9 according to the sixth modified example, the substrate 101 may be bent at the intermediate position in the width direction (the X-axis direction), such that the substrate 101 has a vertically two-folded state.

In the capacitance sensor 100-9 according to the sixth modified example, the second side shield electrode 105 is largely extended in the width direction (the X-axis direction) on the upper surface 101A of the substrate 101. As a result, in the capacitance sensor 100-9 according to the sixth modified example, when the substrate 101 is folded, a part of the second side shield electrode 105 can be disposed on the lower side (on the negative side on the Z-axis) of the other electrodes (the detection electrode 102, the first side shield electrode 103, and the side ground electrode 104) to overlap them as shown in FIG. 39. Therefore, in the capacitance sensor 100-9 according to the sixth modified example, a part of the second side shield electrode 105 can function the same as the back shield electrode 106.

In other words, in the capacitance sensor 100-9 according to the sixth modified example, the back shield electrode 106 is integrally formed with the second side shield electrode 105, and the back shield electrode 106 (a part of the second side shield electrode 105) can be formed on the upper surface 101A of the substrate 101 together with other electrodes. Therefore, it is possible to simplify the manufacturing process of the back shield electrode 106.

In the capacitance sensor 100-9 according to the sixth modified example, a part of the second side shield electrode 105 can cover a side surface of a region between the detection electrode 102 and the back shield electrode 106. As a result, the capacitance sensor 100-9 according to the sixth modified example can prevent an external noise, which comes via the side surface of the region between the detection electrode 102 and the back shield electrode 106, from flowing into the detection electrode 102. Thus, the sensitivity of the detection signal and the SN ratio can be improved.

Moreover, consequently, the capacitance sensor 100-9 according to the sixth modified example can prevent the second AC drive voltage V2 applied to the second side shield electrode 105 and the back shield electrode 106 from being phase-shifted between these electrodes, i.e., can guarantee these electrodes the second AC drive voltage V2 of the same phase. Therefore, it is possible to stabilize the high SN ratio of the detection signal by reducing the parasitic capacitances.

In the example shown in FIG. 39, in the capacitance sensor 100-9 according to the sixth modified example, a support plate 109 composed of resin may be disposed between the two folds of the substrate 101, and the substrate 101 may be fixed in the two-folded state by pasting the substrate 101 on the support plate 109 with an adhesive layer 110.

In the example shown in FIG. 39, in the capacitance sensor 100-9 according to the sixth modified example, the entirety of the upper surface 101A of the substrate 101 is covered with a cover resist 111.

### Seventh Modified Example

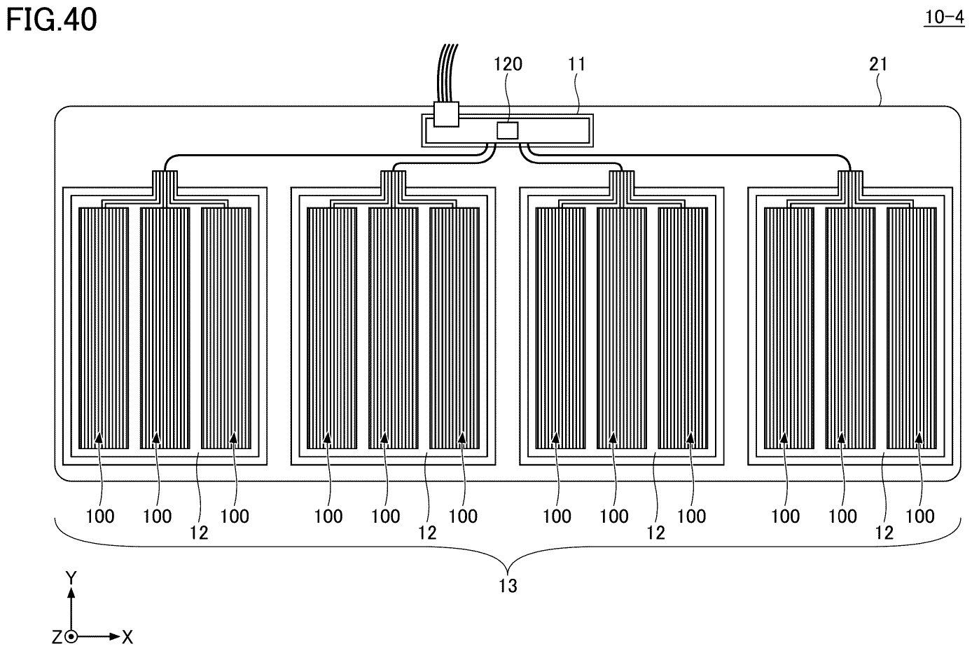

FIG. 40 is a plan view of a capacitance detection device 10-4 according to a seventh modified example. As shown in FIG. 40, the capacitance detection device 10-4 includes a sensor unit 13 composed of a plurality of sensor sheets 12 (in the example shown in FIG. 40, four sensor sheets 12) disposed parallel with each other in the left-right direction (the X-axis direction). Each of the four sensor sheets 12 included in the sensor unit 13 has the same configuration as that of the sensor sheet 12 described in the first embodiment. That is, each of the four sensor sheets 12 of the sensor unit 13 has a plurality of capacitance sensors 100 (in the example shown in FIG. 40, three capacitance sensors 100) disposed parallel with each other in the left-right direction (the X-axis direction).

The detection circuit 120 of the capacitance detection device 10-4 is connected to each of the plurality of capacitance sensors 100 provided on the plurality of sensor sheets 12. For example, in the example shown in FIG. 40, the detection circuit 120 of the capacitance detection device 10-4 is connected to each of the twelve capacitance sensors 100. Thus, the detection circuit 120 of the capacitance detection device 10-4 drives each of the twelve capacitance sensors 100 to enable each of the twelve capacitance sensors 100 detect the detection target 20, such that the detection circuit 120 can acquire the detection result of the detection target 20 from each of the twelve capacitance sensors 100.

The capacitance detection device 10-4 according to the seventh modified example includes the sensor unit 13 including the plurality of sensor sheets 12. Thus, for example, by the sensor unit 13 being disposed on the shelf board 21 of a product shelf, the capacitance detection device 10-4 can detect the display state of a product (the presence or absence of the product, the number of items of the product, and the like) in each of a plurality of product rows 21A by the self-capacitance method by means of the plurality of capacitance sensors 100.

### Eighth Modified Example

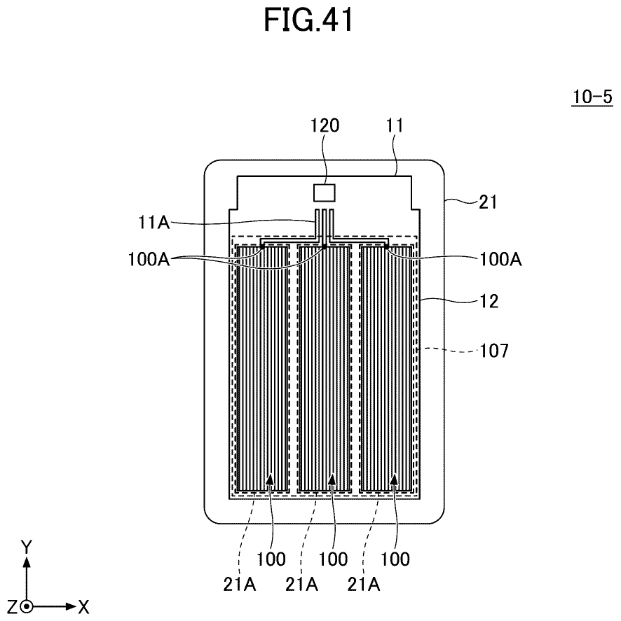

FIG. 41 is a plan view of a capacitance detection device 10-5 according to an eighth modified example. As shown in FIG. 41, the capacitance detection device 10-5 according to the eighth modified example is different from the capacitance detection device 10 according to the first embodiment in that the substrate 101 of the sensor sheet 12 is formed integrally with the circuit board 11. The circuit board 11 is composed of an insulating material, such as glass epoxy resin, glass polyimide resin, paper epoxy resin, paper phenol resin, and the like. As a result, the capacitance detection device 10-5 according to the eighth modified example can avoid wire breakage of the sensor sheet 12 and the like due to impact when the detection target 20 is placed.

### Ninth Modified Example

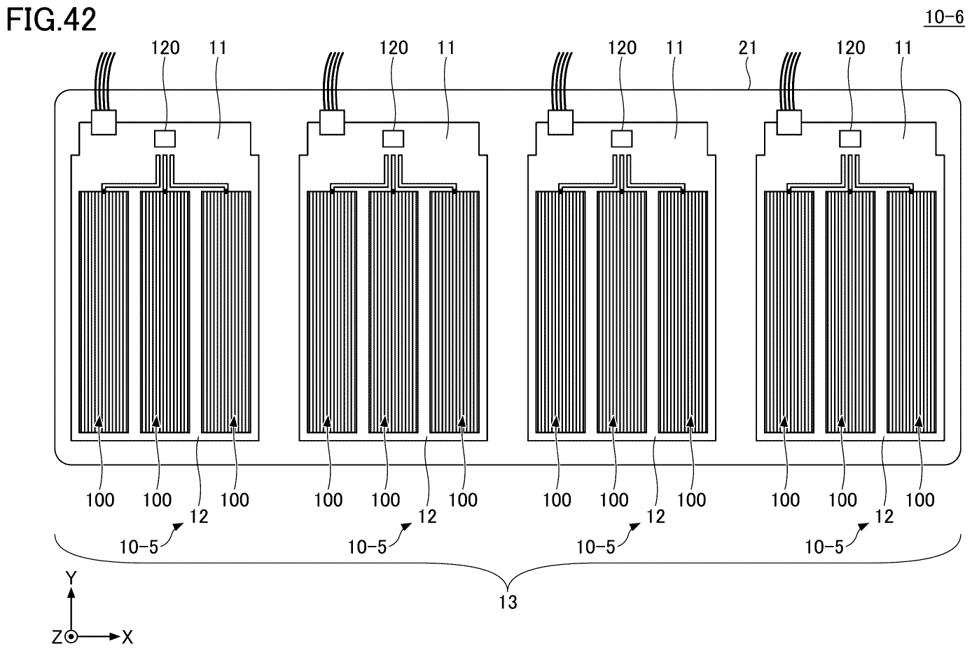

FIG. 42 is a plan view of a capacitance detection device 10-6 according to a ninth modified example. As shown in FIG. 42, the capacitance detection device 10-6 according to the ninth modified example includes a plurality of capacitance detection devices 10-5 (in the example shown in FIG. 42, four capacitance detection devices 10-5) disposed parallel with each other in the left-right direction (the X-axis direction). The capacitance detection device 10-6 according to the ninth modified example is different from the capacitance detection device 10-4 according to the seventh modified example in that each of the plurality of capacitance detection devices 10-5 includes the detection circuit 120.

### Supplementary Information to Fifth Modified Example

### <Configuration of Capacitance Sensor 100-8>

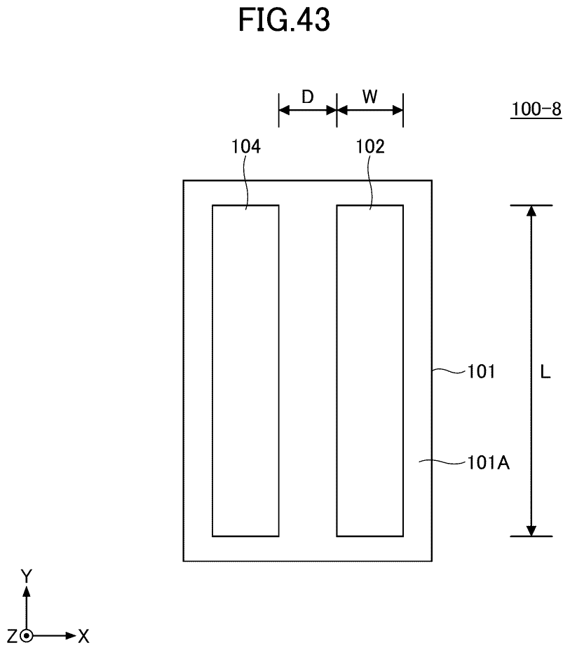

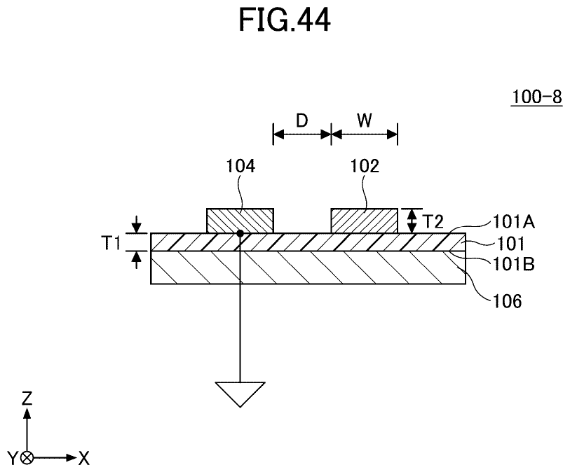

FIG. 43 is a plan view of the capacitance sensor 100-8 according to the fifth modified example. FIG. 44 is a cross-sectional view of the capacitance sensor 100-8 according to the fifth modified example.

In the capacitance sensor 100-8 according to the fifth modified example, as shown in FIGS. 43 and 44, the side ground electrode 104 and the detection electrode 102, both of which are linear in a plan view, are disposed parallel with each other on the upper surface 101A of the substrate 101, and the back shield electrode 106 is disposed on the lower surface 101B of the substrate 101 to face the detection electrode 102.

That is, the capacitance sensor 100-8 according to the fifth modified example is a 2-element capacitance sensor including the side ground electrode 104 and the detection electrode 102 on the upper surface 101A of the substrate 101, and is equivalent to a configuration obtained by excluding the first side shield electrode 103 from the 3-element capacitance sensor 100-5 (see FIGS. 33 and 34) including the first side shield electrode 103, the side ground electrode 104, and the detection electrode 102 on the upper surface 101A of the substrate 101.

As shown in FIGS. 43 and 44, in the capacitance sensor 100-8 according to the fifth modified example, the length of the detection electrode 102 in the longer direction (the axial direction) is defined as the length L, and the width of the detection electrode 102 in the shorter direction (the X-axis direction) is defined as the width W. The interval between the side ground electrode 104 and the detection electrode 102 is defined as the interval D. The thickness of the substrate 101 is defined as the thickness T1. The thickness of the detection electrode 102 is defined as the thickness T2.

### <Circuit Model of Capacitance Detection Device 10-7>

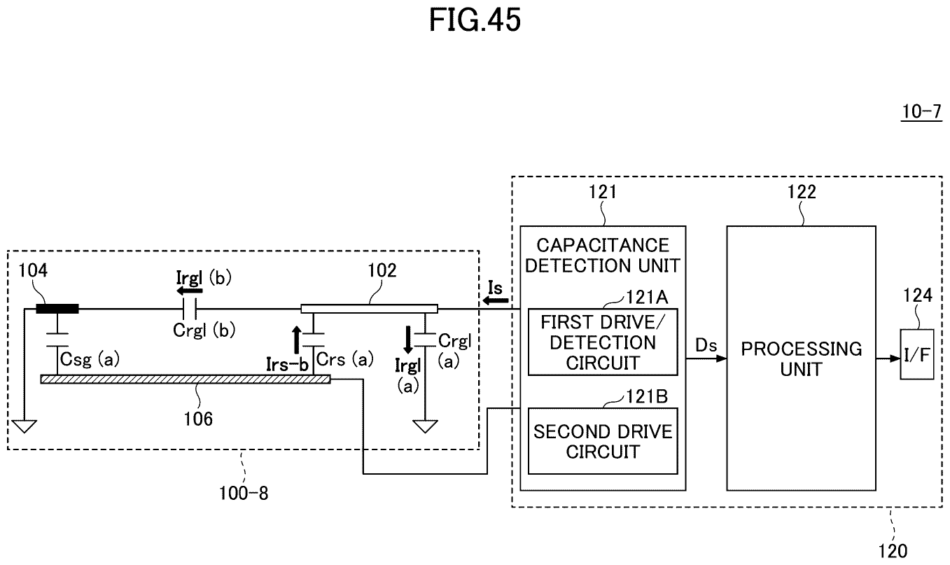

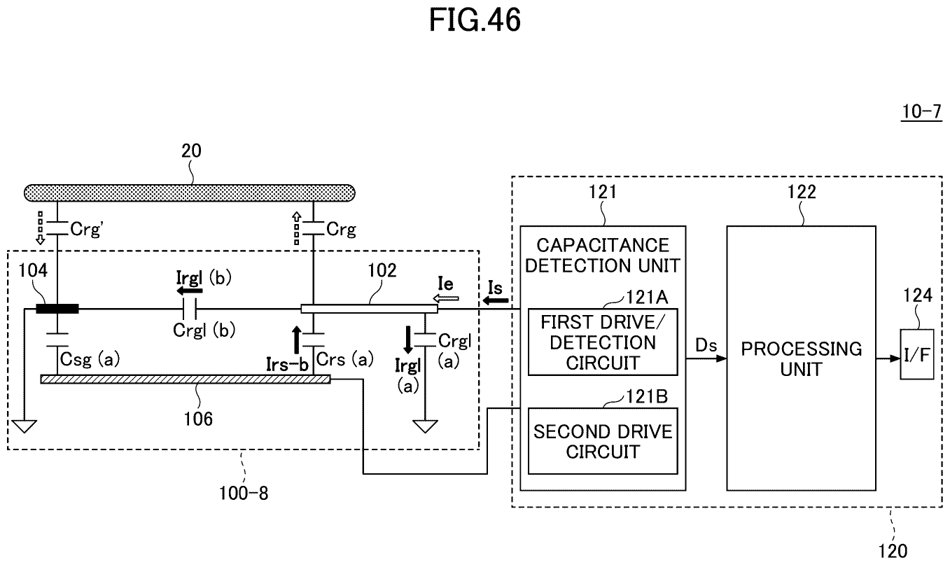

FIG. 45 is a diagram showing a circuit model of the capacitance detection device 10-7 according to the fifth modified example (when no detection target 20 is present on the capacitance sensor 100-8). FIG. 46 is a diagram showing a circuit model of the capacitance detection device 10-7 according to the fifth modified example (when the detection target 20 is present on the capacitance sensor 100-8).

The circuit model of the capacitance detection device 10-7 shown in FIGS. 45 and 46 is different from the circuit model of the capacitance detection device 10 shown in FIGS. 5 and 6 in that it includes the capacitance sensor 100-8 (see FIGS. 43 and 44) including no first side shield electrode 103, instead of the capacitance sensor 100.

Therefore, in the capacitance detection device 10-7, as shown in FIGS. 45 and 46, the following parasitic capacitances are generated in the capacitance sensor 100-8.
Parasitic capacitance between the detection electrode 102 and the ground potential: Crgl(a)
Parasitic capacitance between the detection electrode 102 and the side ground electrode 104: Crgl(b)
Parasitic capacitance between the detection electrode 102 and the back shield electrode 106: Crs(a)
Parasitic capacitance between the side ground electrode 104 and the back shield electrode 106: Csg(a)

The detection circuit 120 included in the circuit model of the capacitance detection device 10-7 shown in FIGS. 45 and 46 is the same as the configuration example of the detection circuit 120 included in the circuit model of the capacitance detection device 10 shown in FIGS. 5 and 6, and the capacitance detection unit 121 of the detection circuit 120 shown in FIG. 7.

In the capacitance detection device 10-7, the detection electrode 102 is driven by the first AC drive voltage V1 being applied from the first drive/detection circuit 121A of the detection circuit 120.

In the capacitance detection device 10-7, the back shield electrode 106 is driven by the second AC drive voltage V2 having the same frequency and the same phase as those of the first AC drive voltage V1 being applied from the second drive circuit 121B of the detection circuit 120.

In the capacitance detection device 10-7, the first drive/detection circuit 121A of the detection circuit 120 detects the change Ie in the current Is flowing through the detection electrode 102 as a change in the capacitance of the detection electrode 102, and outputs the detection signal Ds based on the change Ie in the current Is.

Here, the capacitance detection device 10-7 can reduce the sum (Crgl(a)+Crgl(b)) of the parasitic capacitance between the detection electrode 102 and the ground potential and the parasitic capacitance between the detection electrode 102 and the side ground electrode 104 by the parasitic capacitance (Crs(a)) between the detection electrode 102 and the back shield electrode 106.

Therefore, in the capacitance detection device 10-7, the capacitance detected by the detection electrode 102 when the detection target 20 is mounted to straddle from the detection electrode 102 to the side ground electrode 104 (see FIG. 46) substantially becomes the capacitance (Crg+Crg′) of the detection target 20. Thus, the capacitance (Crg+Crg′) of the detection target 20 can be detected with a high sensitivity as the change Ie in the current Is.

As described above, the capacitance sensor 100-8 according to the fifth modified example employs a 2-element configuration including the detection electrode 102 and the side ground electrode 104 on the upper surface 101A of the substrate 101 and including no first side shield electrode 103.

As a result, in the capacitance sensor 100-8 according to the fifth modified example, the capacitance Crg′ between the detection target 20 and the ground potential can be sufficiently increased since the detection target 20 and the ground potential are closer to each other, compared with the conventional capacitance sensor 910 (see FIGS. 19 and 20) including no side ground electrode 104. That is, the capacitance (Crg+Crg′) of the detection target 20 detected by the detection electrode 102 can be sufficiently increased, and the detection accuracy of the detection target 20 by the detection electrode 102 can be enhanced.

Therefore, the capacitance sensor 100-8 according to the fifth modified example can detect a change in the display state of the detection target 20 with a high sensitivity and at high SNR even under a disadvantageous condition for electrostatic detection of the detection target 20 (for example, a case where the mounting surface of the detection target 20 is far from the detection electrode 102, a case where the conductivity or the dielectric constant of the detection target 20 is low, and the like), and can increase the dynamic range of the output voltage Vo from the operational amplifier 30 shown in FIG. 7.

Further, when compared with the 3-element capacitance sensor 100-5 (see FIGS. 33 and 34) including the detection electrode 102, the side ground electrode 104, and the first side shield electrode 103 on the upper surface 101A of the substrate 101, the capacitance sensor 100-8 according to the fifth modified example can increase the detection accuracy of the detection target 20 by means of the detection electrode 102 because no current that offsets the capacitance (Crg) between the detection electrode 102 and the detection target 20 by the capacitance (Csg′), which would otherwise be generated between the first side shield electrode 103 and the detection target 20, flows through the detection target 20 (that is, between the detection electrode 102 and the ground potential).

In the capacitance sensor 100-8 according to the fifth modified example, the amplitude of the second AC drive voltage V2 applied to the back shield electrode 106 from the second drive circuit 121B is larger than the amplitude of the first AC drive voltage V1 applied to the detection electrode 102 from the first drive/detection circuit 121A.

Thus, the capacitance sensor 100-8 according to the fifth modified example can efficiently reduce the parasitic capacitances Crgl(Crgl(a)+Crgl(b)) between the detection electrode 102 and the ground potential and side ground electrode 104 by the parasitic capacitance (Crs(a)) between the detection electrode 102 and the back shield electrode 106, and can obtain the detection signal having a high SN ratio by means of the detection electrode 102. Further, it is possible to prevent the output voltage Vo from the operational amplifier 30 shown in FIG. 7 from being saturated, and to increase the dynamic range of the output voltage Vo.

In the capacitance sensor 100-8 according to the fifth modified example, the interval D between the detection electrode 102 and the side ground electrode 104 is greater than the interval between the detection electrode 102 and the back shield electrode 106 (i.e., the thickness T1 of substrate 101), and the area by which the detection electrode 102 and the side ground electrode 104 face each other (i.e., the length L of the detection electrode 102×the thickness T2 of the detection electrode 102) is smaller than the area by which the detection electrode 102 and the back shield electrode 106 face each other (i.e., the length L of the detection electrode 102×the width W of the detection electrode 102).

As a result, the capacitance sensor 100-8 according to the fifth modified example can efficiently reduce the parasitic capacitance (Crgl(b)) between the detection electrode 102 and the side ground electrode 104 by the parasitic capacitance (Crs(a)) between the detection electrode 102 and the back shield electrode 106, and therefore, can increase the dynamic range of the output voltage Vo from the operational amplifier 30.

In the capacitance sensor 100-8 according to the fifth modified example, the parasitic capacitance between the detection electrode 102 and the side ground electrode 104 is smaller than the parasitic capacitance between the detection electrode 102 and the back shield electrode 106.

Thus, the capacitance sensor 100-8 according to the fifth modified example can efficiently reduce the parasitic capacitance (Crgl(b)) between the detection electrode 102 and the side ground electrode 104 by the parasitic capacitance (Crs(a)) between the detection electrode 102 and the back shield electrode 106, and therefore, can increase the dynamic range of the output voltage Vo from the operational amplifier 30 shown in FIG. 7.

### Fourth Experiment Example

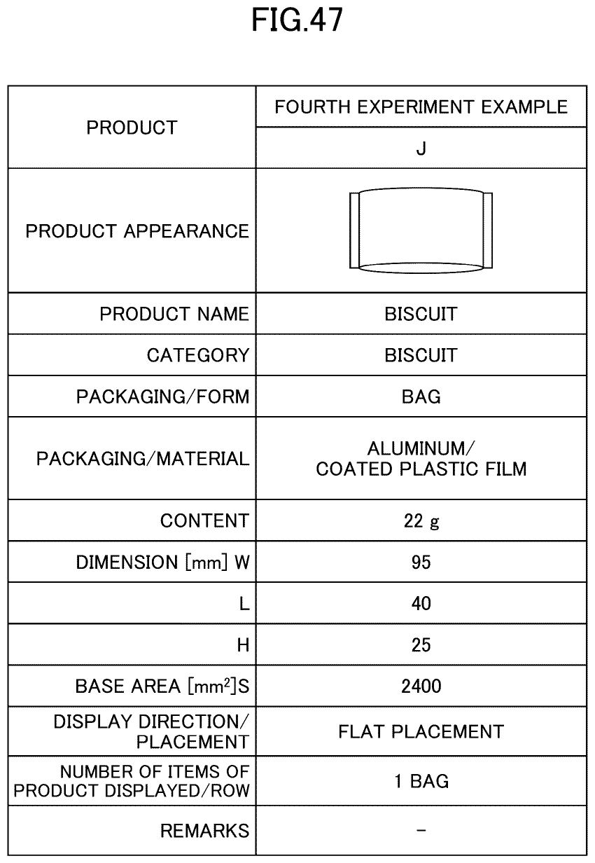

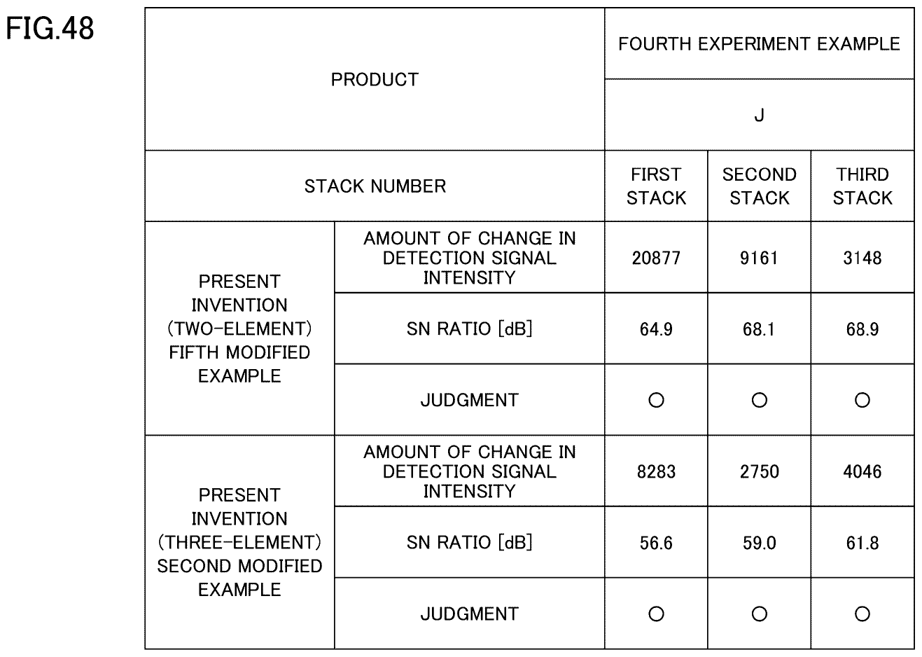

FIG. 47 is a table showing products used in a fourth experiment example. FIG. 48 is a table showing a list of detection results in the fourth experiment example.

In the fourth experiment example, for the product J shown in FIG. 47, a change in the capacitance (the amount of change in the detection signal intensity) accompanying a change in the display state on the shelf board 21 of a product shelf was detected by the 2-element capacitance sensor 100-8 according to the fifth modified example and the 3-element capacitance sensor 100-5 according to the second modified example. Specifically, a change in the capacitance (the amount of change in the detection signal intensity) was detected for each of a case where an item of the product J was placed on and taken out from the first stack, a case where an item of the product J was placed on and taken out from the second stack, and a case where an item of the product J was placed on and taken out from the third stack.
Product J: a bag-packaged confectionery (biscuit, flat placement, placed on 3 stacks)

In the fourth experiment example, as the 2-element capacitance sensor 100-8, one in which one side ground electrode 104 was disposed between two detection electrodes 102 whose ends were electrically connected was used. As the 3-element capacitance sensor 100-5, one in which two first side shield electrodes 103 whose ends were electrically connected were disposed between two detection electrodes 102 whose ends were electrically connected, and one side ground electrode 104 was disposed between the two first side shield electrodes 103 was used.

As shown in FIG. 48, in the fourth experiment example, the 2-element capacitance sensor 100-8 was able to obtain a sufficient amount of change in the detection signal intensity and a sufficient SN ratio (20 dB or greater) in each of the case where an item of the product J was placed on and taken out from the first stack, the case where an item of the product J was placed on and taken out from the second stack, and the case where an item of the product J was placed on and taken out from the third stack.

Meanwhile, as shown in FIG. 48, in the fourth experiment example, the 3-element capacitance sensor 100-5 was able to obtain a sufficient amount of change in the detection signal intensity and a sufficient SN ratio (20 dB or greater) in each of the case where an item of the product J was placed on and taken out from the first stack, the case where an item of the product J was placed on and taken out from the second stack, and the case where an item of the product J was placed on and taken out from the third stack.

As described above, in the fourth experiment example, the 2-element capacitance sensor 100-8 and the 3-element capacitance sensor 100-5 were both able to detect a change in the display state of the product J (the amount of change in the detection signal intensity) with a high sensitivity, since both sensors include the side ground electrode 104.

However, as shown in FIG. 48, in the fourth experiment example, in the case where an item of the product J was placed on and taken out from the first stack, and the case where an item of the product J was placed on and taken out from the second stack, the 2-element capacitance sensor 100-8 was able to obtain a greater amount of change in the detection signal intensity and a higher SN ratio than those obtained by the 3-element capacitance sensor 100-5.

On the other hand, in the fourth experiment example, in the case where an item of the product J was placed on and taken out from the third stack, the 3-element capacitance sensor 100-5 was able to obtain a greater SN ratio than that obtained by the 2-element capacitance sensor 100-8.

It is considered that this is because, in the 3-element capacitance sensor 100-5 including the first side shield electrode 103 between the detection electrode 102 and the side ground electrode 104, the density of the lines of electric force in the vertical direction increases and the detection sensitivity in the vertical direction increases, whereas, in the 2-element capacitance sensor 100-8 including no first side shield electrode 103 between the detection electrode 102 and the side ground electrode 104, the density of the lines of electric force in the horizontal direction increases and the detection sensitivity in the horizontal direction increases.

Therefore, it can be regarded that the 2-element capacitance sensor 100-8 is suitable for use when it is important to detect a change in the display state of a product that is placed at a relatively low position, and the 3-element capacitance sensor 100-5 is suitable for use when it is important to detect a change in the display state of a product that is placed at a relatively high position.

The capacitance sensor 100-8 according to the fifth modified example may further include the back ground electrode 108 that is provided on the lower surface 101B side of the substrate 101 to be spaced apart from and face the back shield electrode 106 and is connected to the side ground electrode 104.

Thus, the capacitance sensor 100-8 according to the fifth modified example can effectively attenuate an external electromagnetic noise coming from the lower side (the negative side on the Z-axis). In addition, the capacitance sensor 100-8 according to the fifth modified example can improve the external noise resistance, can improve the stability of the potential of the side ground electrode 104, and can prevent a noise from flowing into the detection electrode 102. Thus, the stability of the high SN ratio of the detection signal can be improved.

In the capacitance sensor 100-8 according to the fifth modified example, the second side shield electrode 105 disposed parallel with the detection electrode 102 may be further provided on the upper surface 101A of the substrate 101 such that the detection electrode 102 is disposed between the side ground electrode 104 and the second side shield electrode 105, and the second AC drive voltage V2 may be applied to the second side shield electrode 105. This is equivalent to the capacitance sensor 100-7 according to the fourth modified example shown in FIG. 37.

As a result, the capacitance sensor 100-8 according to the fifth modified example can prevent an external electromagnetic noise, which is from the second side shield electrode 105, from flowing into the detection electrode 102, can stabilize the high SN ratio, and can secure a high output.

In this case, the second drive circuit 121B of the detection circuit 120 may make the amplitude of the second AC drive voltage V2 applied to the back shield electrode 106 and the second side shield electrode 105 larger than the amplitude of the first AC drive voltage V1 applied to the detection electrode 102.

As a result, the capacitance sensor 100-8 according to the fifth modified example can detect a change in the display state of the detection target 20 with a high sensitivity and at a high SNR even under a disadvantageous condition for electrostatic detection of the detection target 20 (for example, a case where the mounting surface of the detection target 20 is far from the detection electrode 102, a case where the conductivity or the dielectric constant of the detection target 20 is low, and the like), and can further increase the dynamic range of the output voltage Vo from the operational amplifier 30.

Further, the sensor sheet 12 may have a configuration in which a plurality of capacitance sensors 100-8 according to the fifth modified example are provided, wherein the plurality of capacitance sensors 100-8 are disposed parallel with each other, and the plurality of capacitance sensors 100-8 are provided integrally.

Thus, the sensor sheet 12 can enable each of the plurality of capacitance sensors 100-8 of the sensor sheet 12 to detect the detection target 20 by driving the plurality of capacitance sensors 100-8 of the sensor sheet 12, and can acquire the detection results of the detection target 20 collectively and efficiently from the plurality of capacitance sensors 100-8 of the sensor sheet 12. Further, by forming the sensor sheet 12 on which the plurality of capacitance sensors 100-8 are disposed parallel with each other, it is possible to collectively manage and form the capacitance sensors 100-8 without disposing them individually.

Further, in this case, the capacitance detection device 10 may be configured to include the sensor sheet 12 and the detection circuit 120 connected to each of the plurality of capacitance sensors 100-8 of the sensor sheet 12.

Thus, with each of the plurality of capacitance sensors 100-8 of the sensor sheet 12 connected to the common detection circuit 120, the capacitance detection device 10 can efficiently acquire the detection results of the detection target 20 collectively from the plurality of capacitance sensors 100-8. Therefore, for example, by installing the sensor sheet 12 on a shelf board of a product shelf, it is possible to efficiently detect the display state of the product in each of the plurality of product rows (the presence or absence of the product, the number of items of the product, and the like) by the self-capacitance method by means of the plurality of capacitance sensors 100-8 of the sensor sheet 12.

Alternatively, in this case, the sensor unit 13 may have a configuration including a plurality of sensor sheets 12, wherein the plurality of sensor sheets 12 are disposed parallel with each other.

Thus, the sensor unit 13 can enable each of the plurality of capacitance sensors 100-8 to detect the detection target 20 by driving the plurality of capacitance sensors 100-8 of each of the plurality of sensor sheets 12 of the sensor unit 13, and can efficiently acquire the detection results of the detection target 20 collectively from the plurality of capacitance sensors 100-8. Further, in the sensor unit 13, it is easy to adjust whether to increase or reduce the number of the capacitance sensors 100-8 by increasing or reducing the number of the sensor sheets 12.

Further, in this case, the capacitance detection device 10 may have a configuration including the sensor unit 13 and the detection circuit 120 connected to each of the plurality of capacitance sensors 100-8 of the sensor unit 13.

Thus, with each of the plurality of capacitance sensors 100-8 of each of the plurality of sensor sheets 12 connected to the common detection circuit 120, the capacitance detection device 10 can efficiently acquire the detection results of the detection target 20 from the plurality of capacitance sensors 100-8 of each of the plurality of sensor sheets 12 collectively. Therefore, for example, by installing the sensor unit 13 on a shelf board of a product shelf, it is possible to efficiently detect the display state of the product in each of the plurality of product rows (the presence or absence of the product, the number of items of the product, and the like) by the self-capacitance method by means of each of the plurality of capacitance sensors 100-8 of each of the plurality of sensor sheets 12.

Although one embodiment of the present invention has been described in detail above, the present invention is not limited to the embodiment, and various modifications or changes are applicable within the scope of the spirit of the present invention described in the claims.

What is claimed is:

1. A capacitance sensor, comprising:
a substrate;
a detection electrode disposed on one surface of the substrate;
a first side shield electrode disposed parallel with the detection electrode on the one surface of the substrate; and
a back shield electrode disposed on the other surface of the substrate to face the detection electrode through the substrate,
wherein a first alternating-current (AC) drive voltage is applied to the detection electrode,
a second AC drive voltage having a same frequency and a same phase as those of the first AC drive voltage is applied to the first side shield electrode and the back shield electrode, and
the capacitance sensor further comprises a side ground electrode that is disposed parallel with the detection electrode and the first side shield electrode on the one surface of the substrate, and is connected to a ground potential.

2. The capacitance sensor according to claim 1,
wherein the first side shield electrode is disposed between the detection electrode and the side ground electrode.

3. The capacitance sensor according to claim 1, further comprising:
a second side shield electrode disposed parallel with the detection electrode on the one surface of the substrate,
wherein the detection electrode is disposed between the first side shield electrode and the second side shield electrode, and
the second AC drive voltage is applied to the second side shield electrode.

4. The capacitance sensor according to claim 3,
wherein the second side shield electrode is formed integrally with the back shield electrode and covers a side surface of a region between the detection electrode and the back shield electrode.

5. The capacitance sensor according to claim 1,
wherein the detection electrode, the side ground electrode, and the first side shield electrode have a longer direction in a first direction,
the capacitance sensor further comprises a connection part for connection to a lead wire that is provided at one end in the first direction,
the first side shield electrode includes: two linear parts disposed parallel with the side ground electrode; and a connecting part connecting the two linear parts with each other at the other end in the first direction, and
the detection electrode includes: two linear parts disposed parallel with the side ground electrode; and a connecting part connecting the two linear parts with each other at the other end in the first direction.

6. The capacitance sensor according to claim 3,
wherein the detection electrode, the side ground electrode, the first side shield electrode, and the second side shield electrode have a longer direction in the first direction,
the capacitance sensor further comprises a connection part for connection to a lead wire that is provided at one end in the first direction, and
the second side shield electrode includes: two linear parts disposed parallel with the side ground electrode; and a connecting part connecting the two linear parts with each other at the other end in the first direction.

7. The capacitance sensor according to claim 1, further comprising:
a back ground electrode that is provided on a side of the other surface of the substrate such that the back ground electrode is spaced apart from and faces the back shield electrode, the back ground electrode being connected to the side ground electrode.

8. A sensor sheet, comprising:
a plurality of capacitance sensors, each of which is the capacitance sensor of claim 1,
wherein the plurality of capacitance sensors are disposed parallel with each other, and the plurality of capacitance sensors are provided integrally.

9. A sensor unit, comprising:
a plurality of sensor sheets, each of which is the sensor sheet of claim 8,
wherein the plurality of sensor sheets are disposed parallel with each other.

10. A detection circuit for the capacitance sensor of claim 1, the detection circuit comprising:
a first drive/detection circuit configured to apply the first AC drive voltage to the detection electrode to detect a change in a current flowing through the detection electrode; and
a second drive circuit configured to apply the second AC drive voltage to the first side shield electrode and the back shield electrode,
wherein an amplitude of the second AC drive voltage is larger than an amplitude of the first AC drive voltage.

11. A detection circuit for the capacitance sensor of claim 3, the detection circuit comprising:
a first drive/detection circuit configured to apply the first AC drive voltage to the detection electrode to detect a change in a current flowing through the detection electrode; and
a second drive circuit configured to apply the second AC drive voltage to the first side shield electrode, the second side shield electrode, and the back shield electrode,
wherein an amplitude of the second AC drive voltage is larger than an amplitude of the first AC drive voltage.

12. A capacitance detection device, comprising:
the sensor sheet of claim 8; and
a detection circuit connected to each of the plurality of capacitance sensors included in the sensor sheet.

13. A capacitance detection device, comprising:
the sensor unit of claim 9; and
a detection circuit connected to each of the plurality of capacitance sensors included in the sensor unit.

14. A capacitance sensor, comprising:
a substrate;
a detection electrode disposed on one surface of the substrate; and
a back shield electrode disposed on the other surface of the substrate to face the detection electrode through the substrate,
wherein a first AC drive voltage is applied to the detection electrode,
a second AC drive voltage having a same frequency and a same phase as those of the first AC drive voltage and having an amplitude larger than that of the first AC drive voltage is applied to the back shield electrode, and
the capacitance sensor further comprises a side ground electrode that is disposed parallel with the detection electrode on the one surface of the substrate, and is connected to a ground potential.

15. The capacitance sensor according to claim 14,
wherein an interval between the detection electrode and the side ground electrode is greater than an interval between the detection electrode and the back shield electrode, and an area by which the detection electrode and the side ground electrode face each other is smaller than an area by which the detection electrode and the back shield electrode face each other.

16. The capacitance sensor according to claim 14,
wherein a parasitic capacitance between the detection electrode and the side ground electrode is smaller than a parasitic capacitance between the detection electrode and the back shield electrode.

17. The capacitance sensor according to claim 14, further comprising:
a second side shield electrode disposed parallel with the detection electrode on the one surface of the substrate,
wherein the detection electrode is disposed between the side ground electrode and the second side shield electrode, and
the second AC drive voltage is applied to the second side shield electrode.

18. The capacitance sensor according to claim 14, further comprising:
a back ground electrode that is disposed on a side of the other surface of the substrate such that the back ground electrode is spaced apart from and faces the back shield electrode, the back ground electrode being connected to the side ground electrode.

19. A sensor sheet, comprising:
a plurality of capacitance sensors, each of which is the capacitance sensor of claim 14,
wherein the plurality of capacitance sensors are disposed parallel with each other, and the plurality of capacitance sensors are provided integrally.

20. A sensor unit, comprising:
a plurality of sensor sheets, each of which is the sensor sheet of claim 19,
wherein the plurality of sensor sheets are disposed parallel with each other.

21. A detection circuit for the capacitance sensor of claim 14, the detection circuit comprising:
a first drive/detection circuit configured to apply the first AC drive voltage to the detection electrode to detect a change in a current flowing through the detection electrode; and
a second drive circuit configured to apply the second AC drive voltage to the back shield electrode,
wherein the amplitude of the second AC drive voltage is larger than the amplitude of the first AC drive voltage.

22. A detection circuit for the capacitance sensor according to claim 17, the detection circuit comprising:
a first drive/detection circuit configured to apply the first AC drive voltage to the detection electrode to detect a change in a current flowing through the detection electrode; and
a second drive circuit configured to apply the second AC drive voltage to the back shield electrode and the second side shield electrode,
wherein the amplitude of the second AC drive voltage is larger than the amplitude of the first AC drive voltage.

23. The detection circuit according to claim 21,
wherein the first drive/detect circuit is electrically connected to the detection electrode via a lead wire,
the first drive/detect circuit includes an operational amplifier, a feedback resistor, a feedback capacitor, and a first AC voltage circuit serving as a first AC power source,
the first AC voltage circuit is configured to generate the first AC drive voltage and apply the first AC drive voltage to a non-inverting input terminal of the operational amplifier,
the detection electrode is connected to an inverting input terminal of the operational amplifier via the lead wire,
the operational amplifier is configured to amplify a voltage difference between the inverting input terminal connected to the detection electrode and the non-inverting input terminal to which the first AC drive voltage is applied, and output an output voltage, and
the feedback resistor and the feedback capacitor are in a parallel connection between an output terminal and the inverting input terminal of the operational amplifier, such that negative feedback is applied.

24. A capacitance detection device, comprising:
the sensor sheet of claim 19; and
a detection circuit connected to each of the plurality of capacitance sensors included in the sensor sheet.

25. A capacitance detection device, comprising:
the sensor unit of claim 20; and
a detection circuit connected to each of the plurality of capacitance sensors included in the sensor unit.
